(19) United States
(12) Patent Application Publication
(10) Pub. No.: US 2015/0254788 A1
(43) Pub. Date: Sep. 10, 2015

(54) METHODS AND SYSTEMS FOR IMPROVING SATISFACTION AND DETERMINING ITEM SELECTION AND ASSIGNMENT FOR A GROUP OF USERS

(71) Applicant: EVENTFORTE, INC., Santa Clara, CA (US)

(72) Inventors: Ankit GUPTA, LOS ALTOS HILLS, CA (US); Tittu Thomas NELLIMOOTTIL, LOS ANGELES, CA (US)

(73) Assignee: EVENTFORTE, INC., Santa Clara, CA (US)

(21) Appl. No.: 14/279,247

(22) Filed: May 15, 2014

Related U.S. Application Data
(60) Provisional application No. 61/949,856, filed on Mar. 7, 2014.

(51) Int. Cl. G06Q 50/12; G06Q 30/02

(52) U.S. Cl. CPC G06Q 50/12; G06Q 30/0282

(57) ABSTRACT

Novel methods and systems for organizing events are disclosed. A venue can provide menu items with optional and required ingredients, while an event organizer can provide constraints and attendees can provide menu preferences. An optimization is then carried out to find the best selection within the constraints. Events may be video viewing or meals.

### CROSS REFERENCE TO RELATED APPLICATIONS

The present application claims priority to U.S. Provisional Patent Application No. 61/949,856, filed Mar. 7, 2014, and may be related to U.S. patent application Ser. No. ______, titled “METHODS AND SYSTEMS FOR SECURING VENUE RENTAL AND OPTIMIZING EVENT MANAGEMENT” (Attorney Docket No. P1454-US), filed on even date herewith, the disclosure of both of which is incorporated herein by reference in its entirety.

### TECHNICAL FIELD

The present disclosure relates to event management. More particularly, it relates to methods and systems for improving satisfaction and determining item selection and assignment for a group of users.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 is a flow diagram depicting an approach to assign a meal incorporating personal preferences of attendees according to an embodiment of the disclosure.

FIG. 2 is a block diagram that depicts users' likability of an ingredient and users' rating of a particular menu item in an array or list of arrays according to an embodiment of the disclosure.

FIG. 3 is a block diagram that depicts the presence (or lack of presence) of a required and optional ingredient, respectively, for a menu item in an array or list of arrays according to an embodiment of the disclosure.

FIG. 4 is a block diagram that depicts an arrangement for recommending items according to an embodiment of the disclosure.

FIG. 5 is a diagram depicting an approach for vendor communication over the internet to organizers and optimized event management for said vendor and organizer over the internet with attendees according to an embodiment of the disclosure.

FIG. 6 is a diagram depicting an approach for communication according to an embodiment of the disclosure.

FIG. 7 is a flow diagram depicting an approach for executing a meal and completing related post-processing needs of a meal according to an embodiment of the disclosure.

FIG. 8 illustrates an embodiment of a hardware implementation for the methods of the present disclosure.

FIG. 9 illustrates an embodiment of hardware implementation for the present disclosure.

FIG. 10 is a block diagram that depicts ingredient to ingredient correlation in an array or list of arrays according to an embodiment of the disclosure.

FIG. 11 is a flow diagram depicting a remedy solution in case there are unsatisfied users in item selection at an individual vendor according to an embodiment of the disclosure.

FIG. 12 is an exemplary diagram of a screen displaying information from an application implementing one embodiment of the methods of the present disclosure.

FIG. 13 is another exemplary diagram of a screen displaying information from an application implementing one embodiment of the methods of the present disclosure.

FIG. 14 illustrates an exemplary connection between server and computers.

FIG. 15 is another exemplary diagram of a screen displaying information from an application implementing one embodiment of the methods of the present disclosure.

FIG. 16 is another exemplary diagram of a screen displaying information from an application implementing one embodiment of the methods of the present disclosure.

FIG. 17 illustrates an exemplary method for an attendee of a group video to specify their preferences according to the present disclosure.

FIG. 18 illustrates an exemplary method for a first step for an organizer to initiate a video for group viewing according to the present disclosure.

FIG. 19 illustrates an exemplary method for a final step/display of recommended video items for group viewing according to the present disclosure.

FIG. 20 illustrates an exemplary distinction between selecting menu items, and assigning menu items according to the present disclosure.

FIG. 21 illustrates an exemplary apparatus for the methods of the present disclosure.

FIG. 22 illustrates an embodiment where a buffet selection is included according to the present disclosure.

FIG. 23 illustrates how a menu can be composed of a buffet and singular item sets and how they are different according to the present disclosure.

### SUMMARY

In a first aspect of the disclosure, a computer-implemented method is described, the computer-implemented method comprising: providing, by a computer, vendor-related menu items and cost of said vendor-related menu items, wherein the vendor-related menu items comprise optional and/or required ingredients; providing, by a computer, a set of attendee-related ingredients, wherein the set of attendee-related ingredients comprises attendee-liked and/or attendee-disliked ingredients; providing, by a computer, a set of organizer constraints; selecting, by a computer, a subset of the vendor-related menu items for the attendees, based on the set of organizer constraints and the set of attendee-related ingredients, wherein the selecting comprises establishing a correlation between the attendee-liked ingredients and selected menu items and/or between the attendee-disliked ingredients and selected menu items, thereby obtaining a selected subset; and assigning, by a computer, the selected subset of vendor-related menu items to the attendees, based on the set of organizer constraints and the set of attendee-related ingredients, wherein the assigning comprises establishing a correlation between the attendee-liked ingredients and assigned menu items and/or between the attendee-disliked ingredients and assigned menu items.

In a second aspect of the disclosure, a method to organize an event is described, the method comprising: providing, by a computer, vendor-related event features, wherein the vendor-related event features comprise optional and/or required event specifications; providing, by a computer, attendee-related event features, wherein the attendee-related event features comprise attendee-liked and/or attendee-disliked event features and specifications; providing, by a computer, a set of organizer constraints; and selecting, by a computer, at least one of the vendor-related event features, based on the set of organizer constraints and the attendee-related event features, wherein the selecting comprises establishing a correlation between the attendee-liked event features and selected event features and/or between the attendee-disliked event features and the selected event features.

In a third aspect of the disclosure, a computer-implemented method is described, the computer-implemented method comprising: providing, by a computer, vendor-related menu items and cost of said vendor-related menu items, wherein the vendor-related menu items comprise optional and/or required ingredients; providing, by a computer, a set of attendee-related ingredients, wherein the set of attendee-related ingredients comprises attendee-liked and/or attendee-disliked ingredients; providing, by a computer, a set of organizer-related constraints; and selecting, by a computer, a subset of the vendor-related menu items for the attendees, based on the set of organizer-related constraints and the set of attendee-related ingredients, wherein the selecting comprises establishing a correlation between the attendee-liked ingredients and selected menu items and/or between the attendee-disliked ingredients and selected menu items, thereby obtaining a selected subset.

### DETAILED DESCRIPTION

The present disclosure relates to a computer-implemented approach for organizing events. For example, an event could be a meal; alternatively an event could be, but is not limited to a presentation, video, audio that is displayed to a group of people. In this context an event can be defined as a place where any group of people gathers, where an organizer is someone who manages one or more portions of the event, a vendor can be anyone providing the item, which is composed of ingredients, and where a venue can be any location where the group is gathered for the event.

In this context, the term ingredient can be any constituent part of an item where an item may be a meal, video content, audio content, etc. In the following, the embodiment about meal organization will be described, however other embodiments where the event is not a meal can be inferred from the exemplary terms of the disclosure as described below. For example, a meal comprises choosing a menu, with each menu item comprising ingredients, which are optional and/or required. The attendees and vendors may have different requirements regarding the menu and ingredients. In the context of a meal, an ingredient can be, but is not limited to, carrots or chicken, etc. A meal may also comprise choosing a buffet, where the buffet comprises several items, each item comprising several ingredients. A buffet may also be built by an attendee by choosing a list of ingredients or menu items to form the buffet. The person skilled in the art will understand that, in the following, several embodiments may be modified to include the presence of a buffet instead of, or concurrently with, one or more menu items. A buffet may increase in quantity based on how many of each item within the buffet set each person is expected to eat.

Similarly, in other events, the event may comprise different ingredients. For example, for a video, the ingredients may be, but are not limited to, genre, language, talent (actors), film ratings, and audio or video quality requirements, such as 3D or IMAX. The attendees, organizer and vendors may have different requirements or specifications regarding the above items. For example, some attendees may prefer 3D, and other would prefer avoiding 3D.

One embodiment of the present disclosure relates to a computer-implemented approach for designating meals to customers, an approach that selects and assigns menu items to customers attending respective meals (“attendees”) of a meal based on stored criteria specified by the vendor. The methods and systems of the present disclosure allow negotiated terms between the customers who wish to organize a meal (“organizers”) and the vendor of the meal concerning selection criteria, as well as sharing the stored information about ingredient preferences and prior ratings by the attendees who thereby influence the selection and eventual assignment of menu items.

For other embodiments, an attendee may be somebody who attends the event, for example, watches a video on a network connected, or stand-alone video viewing device; an organizer may be somebody who organizes the event.

Information from organizers and attendees about meal preferences and specifications can be provided to providers via the internet or in person and stored in a non-volatile database in the server of the provider or in physical files with the provider who then analyzes the information using a computer algorithm and provides a recommended set of items to a vendor via the internet which will be available for display to the vendor on an electronic viewing device or in some form of physical communication. The vendor arranges the meal based on the recommendations provided by the provider and the preference criteria of attendees and organizer. After completion of meal, attendees may or may not review the meal, and accordingly modified attendee preferences and behavior are stored and used for influencing preference criteria of meals they subsequently attend.

In some embodiments, the present disclosure comprises an apparatus for communication and execution of item selection and assignment involving three or more distinct parties. The present disclosure is related to the communication and execution of item selection between attendees, organizers, and vendors for a specified group of users.

Organization of a meal for a group of people conventionally involves three entities. Firstly, the vendor who provides the meal, secondly, the group of attendees who attend the meal, and thirdly an organizer who negotiates the terms between the vendor and the attendees such as, but not limited to, maximum number of menu items to be served to each attendee, maximum number of menu items to be served to all attendees, maximum cost for the meal, maximum cost for each attendee, preferred number of menu items, preferred cost of menu items, and time of serving, etc.

Typically the organizer of a meal is oblivious of the ingredient preferences (such as food that cannot be eaten) for each of the individual attendees (due to religious, health or other reasons) at the time of this negotiation with the vendor. The trivial solution of serving each attendee with a generally preferred menu item may not work since individual attendees have individual preferences, and serving every attendee with a different menu item may not be feasible, because in a group setting the vendor may limit the number of menu items of each type that may be cooked for one meal. In the context of a video embodiment, typically the organizer is oblivious to the ingredient preferences of attendees, such as, but not limited to, the preferred genre.

Often this ends up resulting in the creation of a set of meal menu items in which some of the attendees end up being served a menu item that he or she dislikes leading to overall dissatisfaction towards organizer and vendor. In the context of video, it may end up in attendees being unable to find a mutually agreeable video to watch, where one or more attendees inevitably may end up dissatisfied.

Another related scenario involves a situation where the organizer has to choose between multiple menus provided by one vendor or multiple vendors to decide on a menu that will satisfy the maximum number of attendees. This is another complicated problem for the organizer, as he often ends up choosing a menu often based on intuition and personal preferences which may or may not be in line with most of the attendees' individual preferences.

Yet another scenario involves an optimal choice of a vendor based on multiple menus that each vendor presents for various meal types. For example, but not limited to, Lunch at Vendor XYZ might satisfy attendees more than Lunch at Vendor ABC; while a combination of Breakfast, Lunch and Dinner at Vendor XYZ might satisfy attendees less than a combination of Breakfast, Lunch and Dinner at Vendor ABC.

Given the current demand of meal satisfaction (and the corresponding selection and assignment of meals) and the limitations with the prior approaches, an approach of meal designation that does not suffer from the existing limitations is preferred. Especially, an approach which may or may not be on the internet that could allow consideration and integration for individual attendee preferences prior to vendor selection and subsequent meal designation and selection for an overall increased satisfaction of the attendees.

In the following, specific details are provided about the present disclosure. However, the methods and systems of the disclosure can be used without these specific details.

As intended herein, a vendor is an entity which maintains a menu of items to be consumed in a reusable or non-reusable fashion by one or more consumers. For example, in the context of a meal served in a large event, a vendor could be a hotel or restaurant, etc., which hosts the event. In other events, the vendor may be a different business. For example, in the case of video content viewing the vendor could be a streaming video platform, a box office rental or a cinema, etc.

A menu is a table of item specifications which may include, but is not limited to, item price and item description along with optional and/or required ingredients. For example, in the context of a meal served in a large event, the menu could be the full list of menu items, a subset of which the hotel can efficiently prepare for a group of people. In the case of video content viewing, the menu could be a list of movies that are available, a subset of which the video platform can ideally display for a specified group of people.

In another embodiment, a menu may be created using an electronic device like a computer or a tablet, on a website or software provided by the provider to the vendor. The data that the vendor inputs into the electronic device can be relayed to the provider and stored in a non-volatile database on the provider's side.

In another embodiment of this disclosure, the provider may procure the menu and other information of the vendor from a third-party such as a review website and store it in their non-volatile database without involving the vendor directly.

In another embodiment, the provider may consult the vendor and enter the information directly into their non-volatile database.

An item is a mixture of ingredients. In another embodiment, items could be mixtures of ingredients in a specified proportion and mass. In another embodiment, in the context of a meal, an item mixture may further include nutritional information of an item, such as, but not limited to, calorie content. For example, in the context of a meal served in a large event, a vendor could be, but is not limited to, a hotel or restaurant, etc., which hosts the event. The item, in the context of a meal, could be the listing of a particular menu item in the menu along with all the required and/or optional ingredients, description and method of preparation along with quantity of each ingredient in proportion and mass. The item, in the context of a video, could be the listing of a particular video in the menu along with the required and optional ingredients, description, along with the quantity of each ingredient in duration and degree.

An ingredient is the set of basic building-block components of an Item on a menu. For example, in the context of a meal served in a large event, lettuce, carrots, chicken and salt are elements of an ingredient set of the Item “Chicken Salad” on a menu. For example, in the context of a video displayed to a group, comedy, action/adventure, 3D, could be an ingredient set of a particular “Movie Example 1”.

A subset of the list of ingredients is specified as optional ingredients, that is, a set of components in the absence of which the identity of the item is not lost. For example, in the context of a meal served in a large event, where a chicken salad is an item in the menu with lettuce, carrots, chicken and salt as ingredients that are listed as elements of its ingredient set, lettuce and carrots may be specified to belong to the subset called “optional ingredients”. In the context of a video displayed to a group, where “Movie Example 1” is an item, 3D, could belong to the subset called “optional ingredients.”

For any item, ingredients that remain once optional ingredients are removed represent the set called “required ingredients”. In other words, the menu item loses its identity in the absence of any item in the required ingredients list. For example, in the context of a meal served in a large event, where a chicken salad is an item in the menu with lettuce, carrots, chicken and salt listed as elements of its ingredients set, chicken may be specified to belong to the subset called required ingredients. In the context of a video displayed to a group, where “Movie Example 1” is an item, comedy, action/adventure, could belong to the subset called “required ingredients.”

An item instance is an embodiment of an item for delivery to the consumer. It may or may not be subjected to a specified physical or other process before the vendor delivers it to the attendee. For example, in the context of a meal served in a large event, an item instance can be the actual menu item of “chicken salad” that is prepared for a user. Notice that this is different from an item which is an intangible listing of the “chicken salad” on the menu. In the context of a video displayed to a group, the streaming video content or physical video content of any specific video could be the item instance.

Various features of example embodiments of the present disclosure are described in details in the following respective sections: (1) functional overview; (2) menu selection criteria; (3) preferences; (4) menu selection; (5) menu assignment; (6) maximum selection; (7) minimum selection (8) attendee satisfaction (9) menu management; and (10) implementation methodology;

According to an embodiment, a set of vendors registered to a provider define specifications regarding a menu or multiple menus which are collections of sellable Items composed of processed components called ingredients which may include specified proportions. In the context of an item, certain ingredients present in the item may be optional, hence called optional ingredients, while the others will be required, hence called required ingredients.

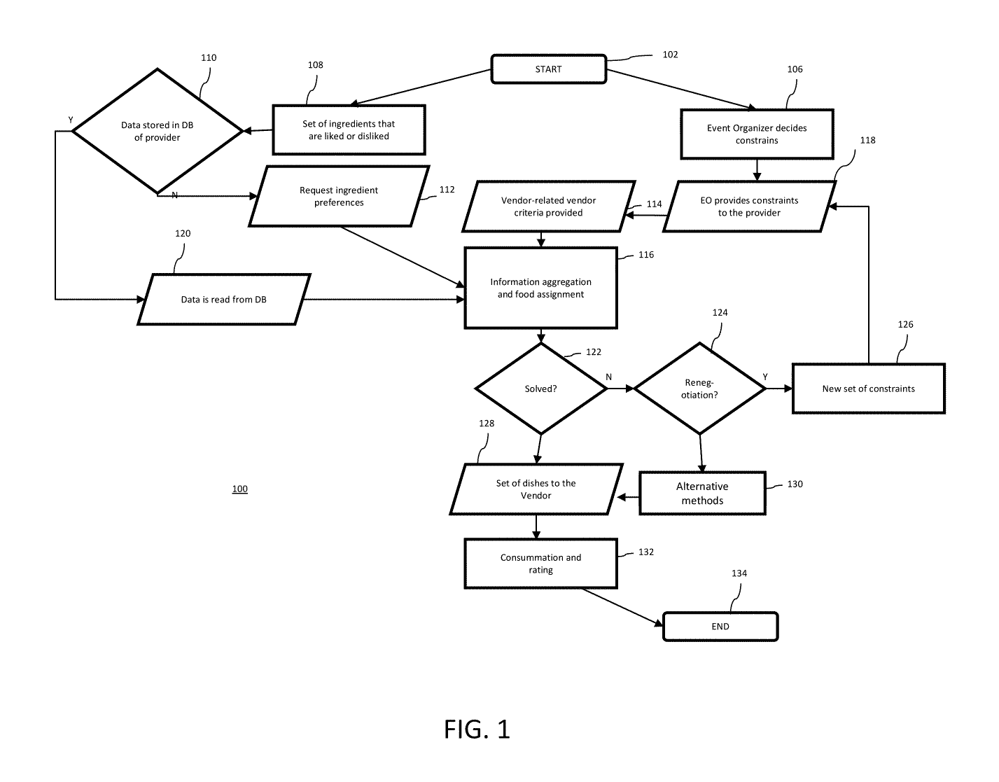

For example, as visible in FIG. 1, an algorithm (100) may start with the event organizer deciding constraints (106) which are then provided to the provider (118). The vendor, which in the context of a meal, may be a hotel or restaurant, etc., may then provide vendor related vendor criteria information to the provider (114). The insertion and transmission of the information can be carried out through the systems of the present disclosure. For example, but not limited to, a computer, smartphone, portable electronic device or tablet running an application, connected to a computer server which hosts a running program and database for the systems of the present disclosure.

For example, the set of constraints may comprise, but is not limited to, maximum number of menu items to be served to each attendee, maximum number of menu items to be served to all attendees, maximum cost for the meal, maximum cost for each attendee, preferred number of menu items, time of serving, and preferred cost of menu items.

Additionally, one or more people attending the meal can decide a set of ingredients that they like or dislike (108). This set of ingredients can be provided to the systems of the present disclosure. The algorithm (100) may then check whether this information, the set of ingredients, is already stored in the non-volatile database of the provider (110). If yes, the set of ingredients is read from the database (120). If no, one or more people provide the preferences of ingredients that they like and/or dislike to the provider (112). Regardless, an inference of ingredient preferences is made by a provider and the stored preferences are corrected over time. In some embodiments, the set of ingredients (108) can be inferred if not explicitly stated. As the person skilled in the art will understand, a process very similar to that of FIG. 1 may occur for other embodiments such as in the context of a video displayed to a group. In some embodiments, the attendee does not select preferences, but these are given by other actors, such as vendors or organizers, or the preferences may also be inferred based on criteria related to the attendee which are available from other sources of information.

After steps (114), and (112) or (120), the provider aggregates the information and attempts to assign a menu item to each attendee such that no attendee is assigned an ingredient they dislike (116).

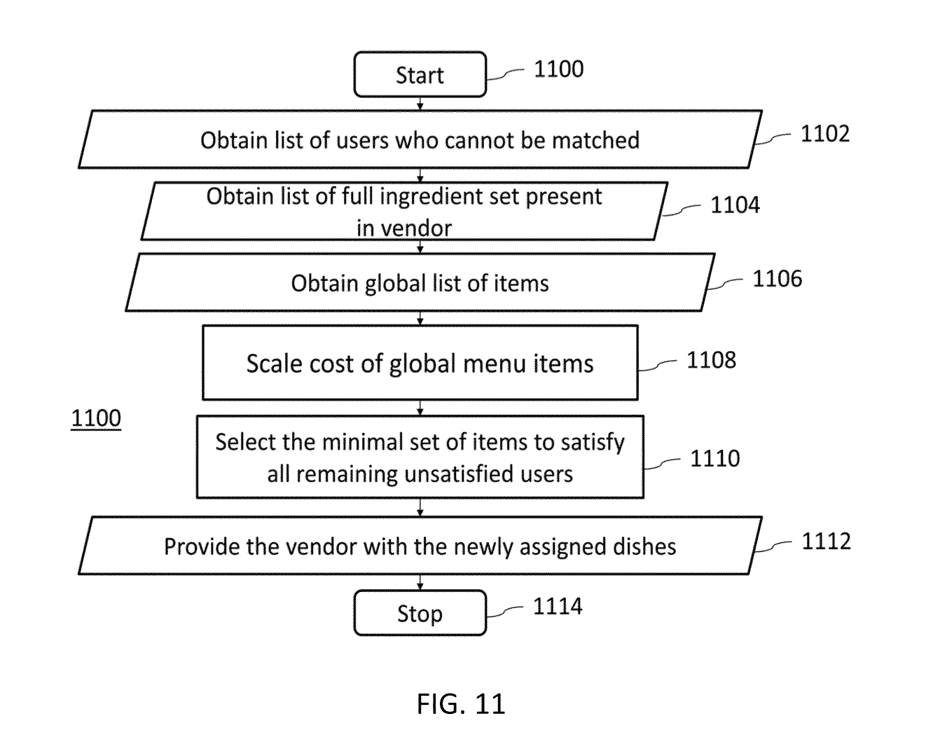

The method (100) then checks whether the proposed solution is acceptable (122). If no, then the method (100) comprises asking the organizer whether they would like to renegotiate the constraints (124). If the organizer accepts a renegotiation, then the organizer decides a new set of constraints pertaining to one or more meals (126). If the organizer does not accept, then the method (100) adopts alternative methods (130). Alternative methods may include, but are not limited to, a remedy solution (as noted in FIG. 11), or a zero set solution where a subset of attendees may remain unsatisfied as they have no menu item that can be provided to them given they dislike an ingredient that is a required ingredient in all menu items.

Referring to FIG. 1, if the solution after check (122) is acceptable or after alternative methods are adopted (130), the provider provides the assigned set of menu items to the venue (128). The attendees can then consume the menu items and rate them, with the ratings stored in a non-volatile database (132). The algorithm (100) therefore reaches an end (134).

According to an embodiment, the provider maintains a record of the ratings of each item in the menu(s) of the vendor.

According to an approach, another set of subscribers of the provider whom can be referred to as attendees, can specify their preference of individual Ingredients for example, but not limited to, as zero or one, zero indicating dislike of that ingredient, and one indicating liking of the ingredient; or in general any other scoring scheme which admits a continuous value; or any other scoring scheme which can be scaled reasonably to a continuous or discrete value.

An item instance can be defined as a singular embodiment of a single item in the menu.

Each item on the menu may be further specified by the vendor to have a cost when realized into an item instance.

An event is defined as a result of a two-step process that

1. selects a subset of items called “selected items” from the menu and

2. assigns item instances of items in “selected items” to attendees.

In some embodiments, the two steps above may be separated and may not require the other one. For example, a selection may be carried out without assignment. Event may be, but not limited to, a meal or a movie assignment for a group of people.

This approach can be used in part or in whole to do both of the two-steps in the process or a singular part, while leaving the other up to any manual decision.

Each item on the menu can be further specified by the vendor as being classified into categories that define how they can be combined into selected items. This classification can be termed “meal type”. For example, if there exist 3 items A, B, C of “meal type” L, D and L respectively, in a set of selected items for a meal of “meal type” L, B may not be served.

Each item on the menu can be further specified by the vendor as being classified into categories that define what stage of the meal the item is consumed at. This classification can be termed “course type”.

According to an approach, a customer of the provider, who can be referred to as the organizer, negotiates with the vendor and agrees upon specifications of a meal such as, but not limited to:

a. meal type of all items selected into selected items set

b. number of items of each course type to be included in selected items

c. maximum and minimum number of item instances of each course type to be made available to each attendee

d. maximum price of all items in the menu

e. minimum rating of any item served

f. identifiers of attendees

g. time and date of serving

In the context of video content for a group, specifications may be, but are not limited to:

a. video type of all items selected into selected items set

b. maximum price of all items in the menu

c. minimum rating of any item served

d. identifiers of attendees

e. duration of intended video display

Attendee satisfaction is defined as a scalable metric (continuous or discrete) that assumes based on any fashion, a higher value when the attendee is assigned item instances which contain ingredients that the attendee likes more than dislikes. Attendee satisfaction can also assume a higher value when the attendee is assigned menu items that have been rated higher by the attendee or according to the provider's records. Items that contain optional ingredients that are disliked by an attendee, may be embodied sans the disliked item and hence keep the attendee satisfied.

The present disclosure relates to a method whereby the provider aggregates the specifications provided by the vendors, attendees and organizer and will attempt to determine a meal that will simultaneously, but is not limited to, maximize attendee satisfaction and optimize the total cost of the meal in a pre-determined fashion.

A possible embodiment of the disclosure for a meal would be when an event is being organized in a hotel (the vendor) by an event organizer (the organizer). Food and beverage offerings (items) from the lunch menu (menu) will contain optional and required ingredients such as salt, red meat, etc. (elements of ingredients which consists of optional ingredients and required ingredients). A possible embodiment of the disclosure for a video displayed to a large group would be when an event is being organized in a cinema (the vendor) by an event organizer (the organizer). Movie offerings (items) from the video menu (menu) will contain optional and required ingredients such as comedy, action/adventure genres, 3D, IMAX, etc. (elements of ingredients which consists of optional ingredients and required ingredients).

According to one embodiment of the disclosure, a subset of items can be selected from the menu according to specifications such that a maximal number of attendees are satisfied by the delivery of the “item instances”. In such an embodiment, all possible subsets of items from the menu can be evaluated and the number of satisfied users can be counted for each instance. Subsequently, the combination or multiple combinations which maximize the number of satisfied users can be chosen.

For example, an instance of a menu consists of items I1, I2, I3, and users U1, U2, U3 and U4 need to be delivered items from this menu and between 1 and 2 item instances each. Attendees have indicated the following in regards to ingredients present in items, as presented in Table 1.

TABLE 1

| | I1 | I2 | I3 |
|---|---|---|---|
| U1 | OK | NOT OK | OK |
| U2 | OK | NOT OK | NOT OK |
| U3 | NOT OK | NOT OK | OK |
| U4 | OK | OK | OK |

All possible combinations of items can be counted, and the number of satisfied attendees can be calculated as follows, as shown in Table 2

TABLE 2

| Subset | Satisfied | Number Satisfied |
|---|---|---|
| { } | { } | 0 |
| {I1} | {U1, U2, U4} | 3 |
| {I2} | {U4} | 1 |
| {I3} | {U1, U3, U4} | 3 |
| {I1, I2} | {U1, U2, U4} | 3 |
| {I2, I3} | {U1, U3, U4} | 3 |
| {I1, I3} | {U1, U2, U3, U4} | 4 |
| {I1, I2, I3} | {U1, U2, U3, U4} | 4 |

Hence, in this example, selection of either subsets {I1,I3}, as well as {I1,I2,I3} both yield a maximal satisfaction based on conditions described above. One of the two solutions can be provided to the vendor. However, if there is an additional constraint such as a maximum number of items (as in the example above), then one of the two solutions may be unacceptable.

According to an embodiment of the disclosure, in conjunction with specification of whether an attendee likes or dislikes an item, the attendee also specifies the list of ingredients that he/she dislikes, which leads to the computation of a table, such that the attendee is “not ok” with Items that contain a disliked ingredient as a required ingredient in it. In another embodiment, implicit inferences may be made that correct the accuracy of the list over time. In another embodiment, implicit inferences may be made in regards to attendee preferences in place of, or in combination with, explicit specifications.

According to another embodiment of the disclosure, the vendor may require multiple equally good solutions to be provided.

According to another embodiment of the invention, constraints may be added or removed depending on the need. Based on to the example above in Table 1 and 2, and describing an additional embodiment building on said example, one or more constraints may be added, such that, only two out of three items from the menu may be chosen in a selected items set. Adding such a constraint, a single solution remains, {I1, I3}.

According to one embodiment of the disclosure, after selecting the set called “selected instances”, the organizer may allow the individual users to choose from selected instances the items of their choice for delivery.

According to another embodiment of the disclosure, there may be a need to select items from the menu into the selected items set while maximizing an objective function which maximizes or minimizes the number of “soft constraints”. Here “soft constraints” are defined as constraints that need not be strictly adhered to, however, whether the constraint can be satisfied is meaningful in the context of an objective function to find the best solution to the problem. For example, in the example illustrated above, an additional soft constraint could be added, that items with rating less than 4 may not be selected, for example, according to Table 3.

TABLE 3

| | I1 | I2 | I3 |
|---|---|---|---|
| U1 | OK | NOT OK | OK |
| U2 | OK | NOT OK | NOT OK |
| U3 | NOT OK | NOT OK | OK |
| U4 | OK | OK | OK |
| Average Ratings | 2 | 5 | 3 |

Continuing with the above example, all possible combinations of items can be counted, and the number of satisfied attendees can be calculated, as shown in Table 4.

TABLE 4

| | | | Rating | |
|---|---|---|---|---|
| | | | condition | Number |
| Solution# | Subset | Satisfied | satisfied? | Satisfied |
| 1 | { } | { } | 1 | 0 |
| 2 | {I1} | {U1, U2, U4} | 0 | 3 |
| 3 | {I2} | {U4} | 1 | 1 |
| 4 | {I3} | {U1, U3, U4} | 0 | 3 |
| 5 | {I1, I2} | {U1, U2, U4} | 0 | 3 |
| 6 | {I2, I3} | {U1, U3, U4} | 0 | 3 |
| 7 | {I1, I3} | {U1, U2, U3, U4} | 0 | 4 |
| 8 | {I1, I2, I3} | {U1, U2, U3, U4} | 0 | 4 |

Clearly the solutions 7 and 8 in Table 4 do not satisfy the soft constraints of rating minimums, however if the objective is to find a selected items set that satisfies all users, they may still be chosen as a solution since, in this example, these solution sets are not limited by hard constraints such as ingredient preference of the attendee.

According to one embodiment of the disclosure, any constraint can be toggled to be hard or soft, and whether the soft constraints can be satisfied or not may be used in an objective function to find optimal solutions.

According to another embodiment of the disclosure, there may be a need to assign the selected items to individual attendees, while maximizing or minimizing an objective function that is a linear or non-linear function of price of item instances and/or number of item instances and/or number of satisfied soft constraints. For example, let maximum number of items that can be selected for the group be two. Let the prices of the items be 10, 8, 14 and 6 per item instance. Hence from the solutions shown in Table 4, Solution 7 will satisfy all users. The selected items can be assigned in the following way as shown in Table 5 below (assuming that each attendee is served one and only one menu item)

TABLE 5

| Assignment number | U1 | U2 | U3 | U4 | Total price |
|---|---|---|---|---|---|
| 1 | I1 | I1 | I3 | I1 | 44 |
| 2 | I1 | I1 | I3 | I3 | 48 |
| 3 | I3 | I1 | I3 | I1 | 48 |
| 4 | I3 | I1 | I3 | I3 | 52 |

If the objective is to minimize the price, Assignment number 1 is chosen as the optimal one since it minimizes the total price.

According to another embodiment of the disclosure, the attendee will define, either implicitly or explicitly, the ingredients that he/she dislikes and the methods described in the present disclosure will only consider the attendee satisfied if the items containing those ingredients are avoided when item instances are created.

According to one embodiment of the disclosure, items are selected into the “selected items” set either manually or using an automated method of the kind described above, and the assignment of the item instances to the attendees are done in a manner that maximizes or minimizes an objective function that is a linear or non-linear function of price of item instances and/or number of item instances and/or number of satisfied soft constrains.

According to one embodiment of the disclosure, the entire process from selection to assignment while maximizing or minimizing an objective function that is a linear or non-linear function of price of item instances and/or number of item instances and/or number of satisfied soft constraints is automated using mathematical tools. Such mathematical tools may involve, but are not limited to, binary integer linear programming. For example, considering a scenario where there are four attendees U1, U2, U3, and U4 who require an assignment from a menu with items I1, I2, I3 and I4. Their like/dislike and prices and average ratings of the menu items based on historical reviews are specified in Table 5.

TABLE 5

| | I1 | I2 | I4 | I3 |
|---|---|---|---|---|
| U1 | OK | NOT OK | OK | OK |
| U2 | OK | NOT OK | OK | NOT OK |
| U3 | NOT OK | NOT OK | OK | OK |
| U4 | OK | OK | NOT OK | OK |
| Average Ratings | 2 | 5 | 3 | 3 |
| Price | 10 | 8 | 14 | 6 |

The organizer may want the hotel to deliver item instances to the attendee such that a minimum of 1 and a maximum of 2 qualifying item instances are delivered to each attendee and the total cost of the menu items is less than or equal to 100, such that a maximum of 2 items are selected into selected item set.

In one method of the present disclosure, this above problem can be looked at as a sub problem of candidate item sets. For example, {I1,I2} and formulating a binary integer linear programming problem:

Let X1, X2, be binary integers indicating whether item 1 and item 2 are delivered to U1;

Let X3, X4, be binary integers indicating whether item 1 and item 2 are delivered to U2;

Let X5, X6, be binary integers indicating whether item 1 and item 2 are delivered to U3;

Let X7, X8, be binary integers indicating whether item 1 and item 2 are delivered to U4;

Let X=(X1, X2 . . . . X8).

The following constraint constructed using fields in table 5 makes sure that no Attendee is assigned an item instance from {I1, I2} he/she dislikes:

[01011100]X^{T}≦0.

The following constraint constructed using fields in table 5 makes sure that the primary filter is such that U1 is constrained to be delivered more than or equal to 1 item instance:

[11000000]X^{T}≧1.

The following constraint constructed using fields in table 5 makes sure that the primary filter is such that U1 is constrained to be delivered less than or equal to 2 item instance:

[11000000]X^{T}≦2.

Similar linear constraints can be constructed for each condition.

An optimization function that minimizes the price can be:

minimize([108108108108]X^{T}).

Formulating the above problem and solving using standard linear programming solvers such as, but not limited to, simplex method, will provide the best objective function as well as an assignment of menu items for this particular subset of items.

Similarly, all subsets may be explored and the subset that gives maximal value for the optimization function can be chosen along with the assignment.

In another embodiment the objective score associated with each subset is stored and every possible subset is displayed, sorted by the objective score of the subset.

Alternative methods involving more complicated binary integer programming formulations preclude the need for repeated sampling and can also be implemented in one embodiment of the disclosure.

According to one embodiment, the selection phase involves menu items called buffet sets which are associated with multiple items, a minimum quantity, and that may or may not be at a pre-set discount. The buffet set selection maintains a minimum quantity threshold for every one of the multiple item instances within the buffet set as prescribed by the venue, while obeying all the other organizer and attendee event constraints.

According to another embodiment, the quantity of each of the multiple item instances within a buffet set may be increased beyond its respective minimum threshold quantity for the purpose of satisfying maximal organizer and attendee event constraints.

According to another embodiment, the selection phase could involve both the combination of menu items that include buffet set instances and also singular item instances. The assignment in this embodiment may involve optimizing the price of the meal such that a portion of attendees are assigned singular item instances who cannot otherwise be satisfied by the buffet set instance, while the other portion of attendees is assigned the buffet set instance such that the quantity of each of the multiple item instances beyond the threshold necessary within the buffet set instance is estimated appropriately. As the person skilled in the art will understand, a process very similar to that which determines singular item instance assignment can be used for determining the quantity estimation of a buffet set instance.

According to one embodiment of the disclosure, boundaries for the number of items belonging to each course type and/or meal type, such as the selected items set, can be chosen suitably before assignment.

According to one embodiment of the disclosure where multiple meals may be planned for the same set of users, the algorithm may do the assignment of item instances to individual users. For example, the same user is assigned different items for meals under the constraints governing the assignment. For example, if user X can consume items A, B, C and three meals need to be planned for user X, the algorithm will try to maximize the number of different item instances that X may consume by providing him with A, B, C respectively instead of just A for all three meals. In the context of a video displayed to a large group, if user Y out of the group has watched items D, E out of a set of D, E, F, G, then the algorithm may avoid displaying items D, E to the group.

According to one embodiment of the disclosure, multiple constraints and scenarios described above can be combined in a logical fashion.

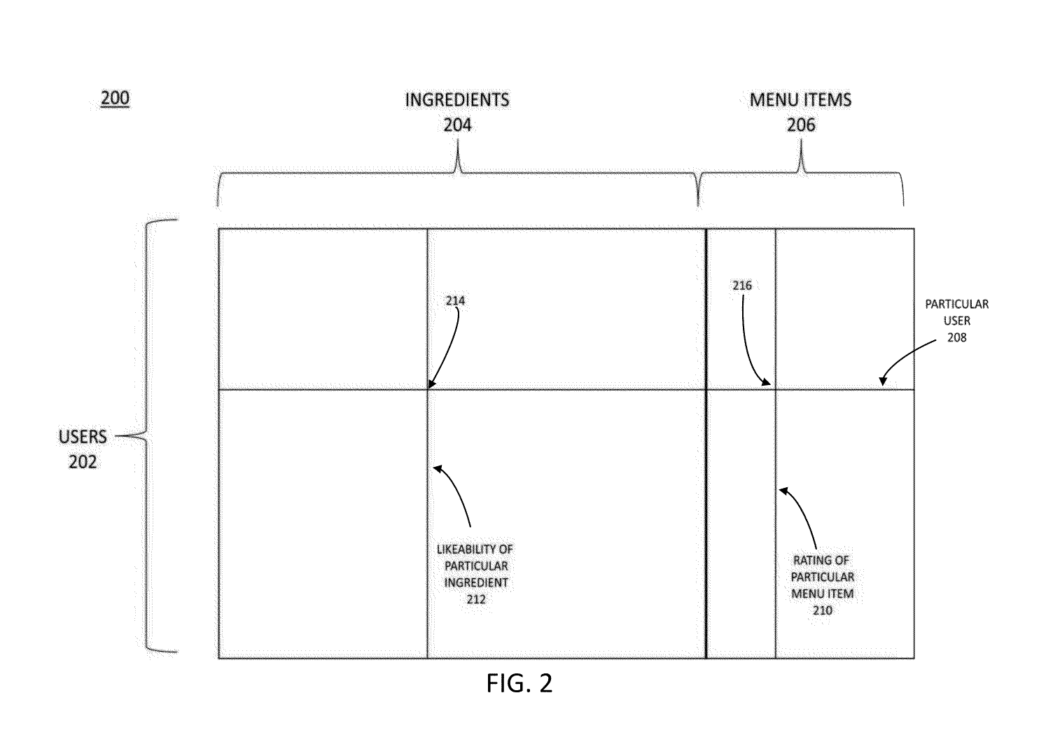

FIG. 2 describes the relation between users and the user-specific data in a graphical form (200). Each horizontal line in the table (200), such as a line referring to a particular user (208), represents the data corresponding to a single user. All users are present on the vertical axis (202). Each vertical line of the graph (200) lists all the user preferences to a particular ingredient, for example line (212) for a specific ingredient plots all the different degrees of appreciation of an ingredient by the different users. Therefore the likeability of all ingredients is illustrated along the horizontal axis (204).

The menu items section of the graph (200) is along horizontal axis (206). For example, the ratings corresponding to a particular menu item for all users is displayed along vertical line (210).

The intersection point (214) represents a point on the graph (200) which shows a particular ingredient preference (212) of a particular user (208). The intersection point (216) represents another field on the graph (200) which represents the rating of a particular menu item (210) by a particular user (208).

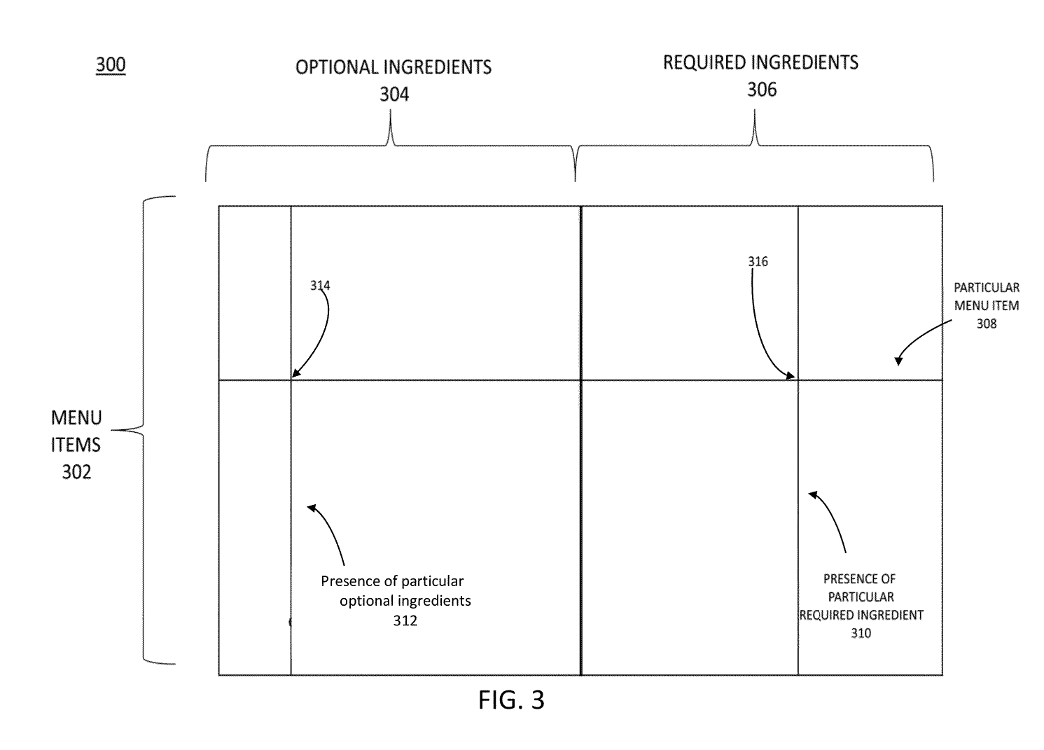

FIG. 3 shows the presence of various ingredients in multiple menu items and describes if they are optional or required. Each horizontal line of graph (300) records the presence or absence of an ingredient. For example, horizontal line (308) represents a particular menu item. The graph (300) is divided into two parts, the left side (304) is for optional ingredients and the right side (306) is for required ingredients. Each vertical line on the left side (304) describes the presence or absence of a specific optional ingredient in each item from the menu. For example, vertical line (312) represents the presence of a particular optional ingredient.

Each vertical line on the right side denotes the presence or absence of a specific required ingredient in each item from the menu, for example vertical line (310) represents the presence of a particular required ingredient. Intersection point (314) shows a field which denotes the presence of a particular optional ingredient (312) in a particular menu item (308). Intersection point (316) shows a field which denotes the presence of a particular required ingredient (310) in a particular menu item (308). According to an approach, another set of subscribers of the provider whom can be referred to as attendees, can specify their preference of individual Ingredients, for example, but not limited to, as zero or one, zero indicating absence of that ingredient, and one indicating presence of the ingredient; or, in general, any other scoring scheme which admits a continuous value; or any other scoring scheme which can be scaled reasonably to a continuous or discrete value.

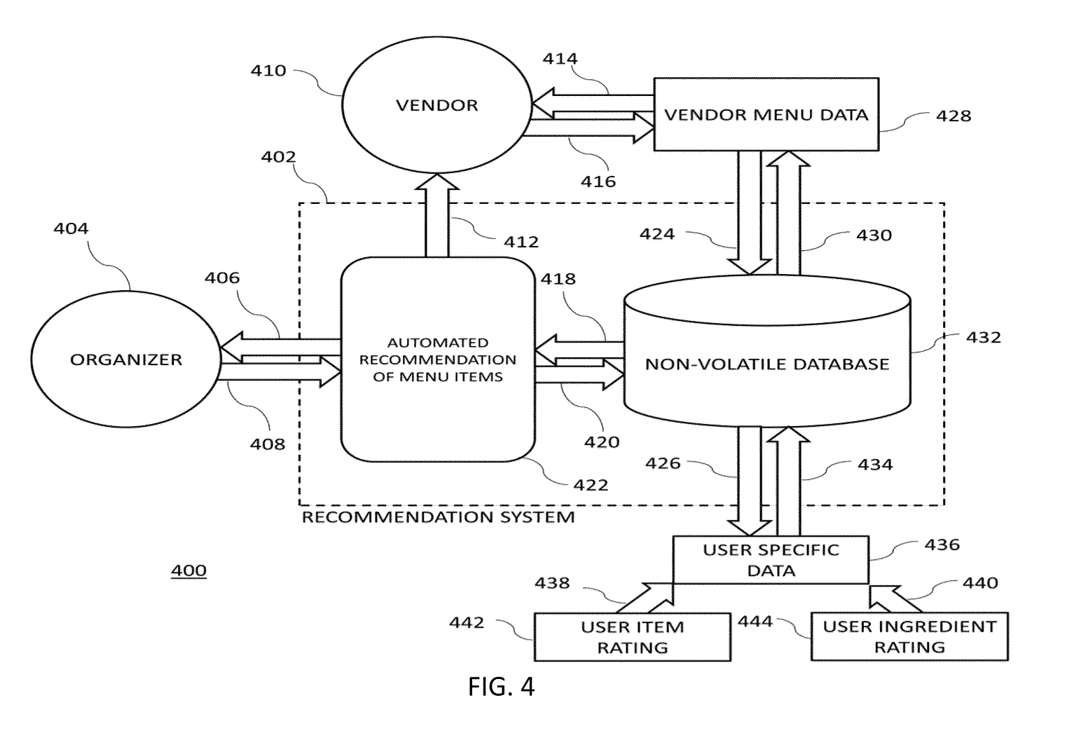

FIG. 4 illustrates one embodiment of the methods and systems of the present disclosure (400). In FIG. 4, an organizer (404) can request recommendations. The recommendation system (402) can provide automated recommendations of menu items including single items and buffet sets (406) to the organizer (404), or (412) to the vendor (410). The recommendation system (402) can accept (424) menu data (428) from vendors (410), as well as accept (434) user specific data (436).

A database (432) can store the data from vendors (410). users (436) and organizers (404), e.g. organizer preferences, and process them in order to obtain recommendations (422). The recommendations (422) may be provided directly to vendors (412, 410). The user specific data (436) is composed of user item rating (442) and user ingredient rating (444). If necessary, the organizer (404) can change a setting and have the recommendation system (402) run again as shown by arrows (406, 408).

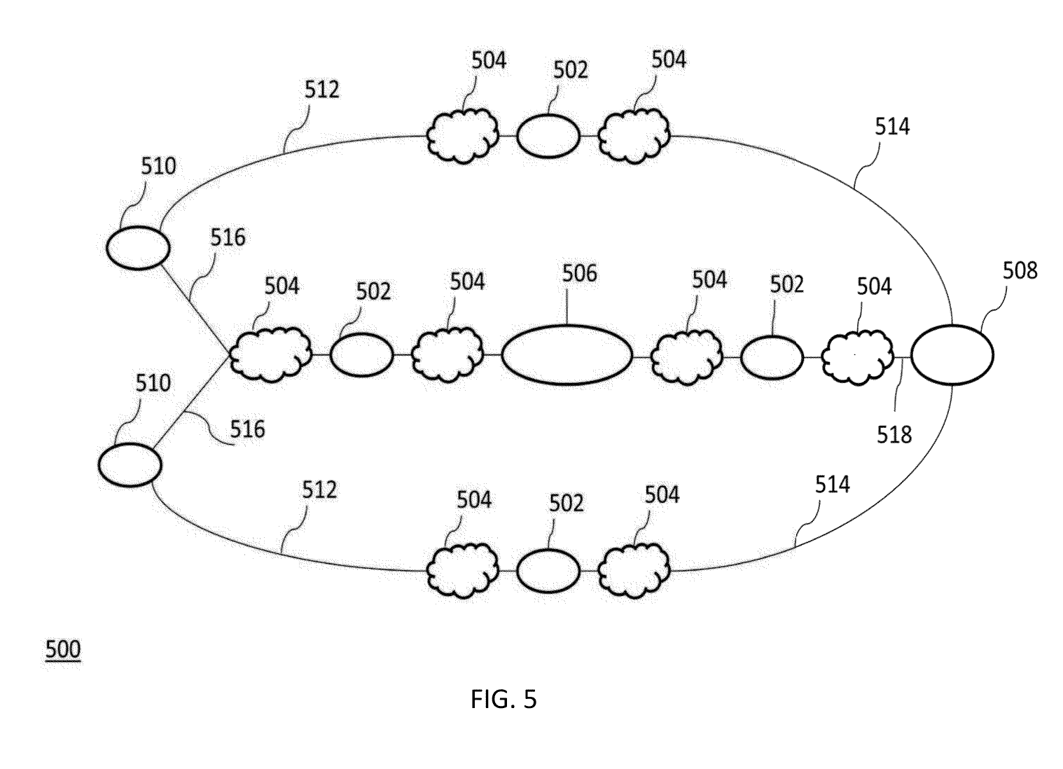

FIG. 5 illustrates an exemplary communication system (500) between attendees, vendors and organizers. An attendee (510) can communicate through an internet connection device (504) with a provider (502) through path (516). The provider (502) can communicate with the attendee (510), organizer (506) and vendor (508). An attendee can communicate with a provider also through channel (512), and, in turn, a provider (502) can also communicate directly with a vendor (508) through channel (514). The organizer (506) can communicate with the vendor (508) through communication channel (518) by way of the provider. The devices of FIG. 5 may also operate on a private network rather than a public network.

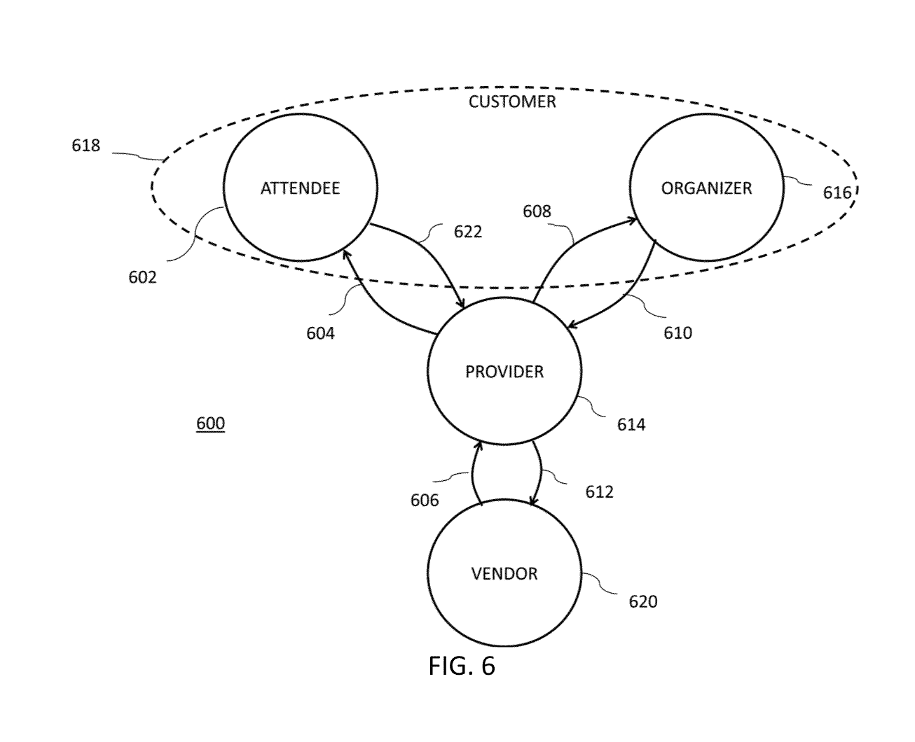

FIG. 6 illustrates an exemplary communication system (600) between attendees, vendors and organizers. An attendee (602) can communicate with a provider (614), or vice versa, through channels (604, 622). An organizer (616) can communicate with a provider (614), or vice versa, through channels (608, 610). A provider (614) can communicate with a vendor (620), or vice versa, through channels (606, 612).

Vendor has been represented outside of the ‘customer’ set (618) for clarity of explanation, but additional embodiments are possible where the vendor can be also seen as a customer.

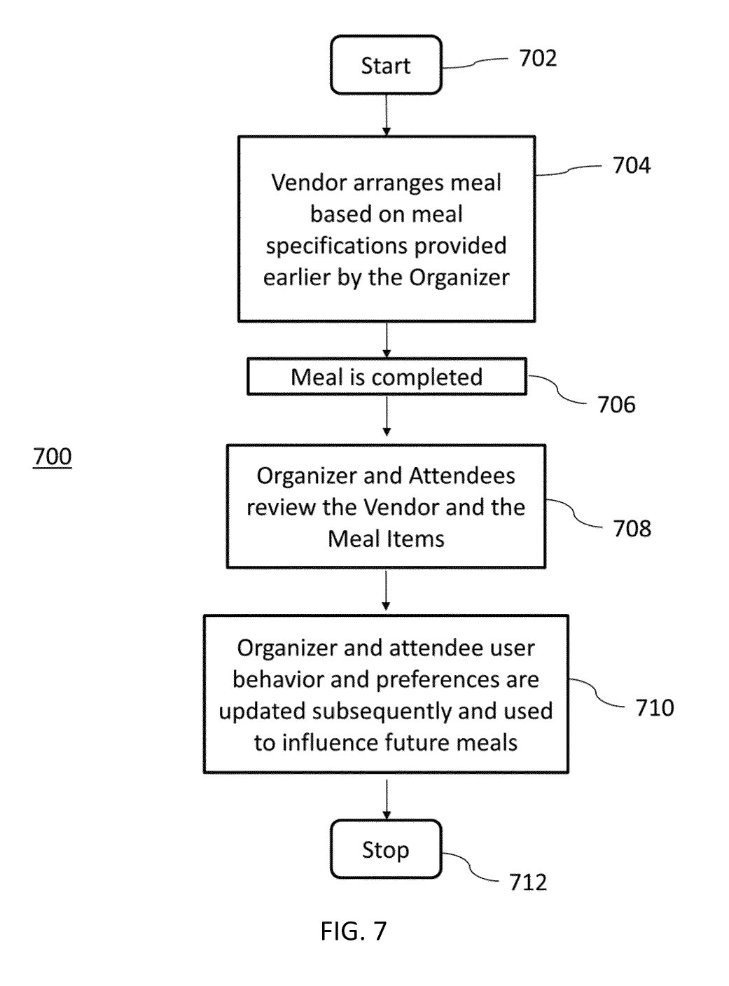

FIG. 7 illustrates an exemplary flow diagram (700) for a method of the present disclosure. The diagram starts (702) with a vendor arranging a meal based on meal specifications provided earlier by the organizer and providing meal instances to attendees (704). The meal is then complete (706).

Subsequently, organizer and attendees review the vendor and the meal items (708). The organizer user behavior and attendee behavior and preferences are then updated based on step (708) and used to influence future meals (710). The method then concludes (712). As the person skilled in the art will understand, a process very similar to that of FIG. 7 may occur for other embodiments such as in the context of a video displayed to a group.

In some embodiments of the present disclosure, the optimization of menu items selection assigned to attendees is based on requesting changes in a certain menu item, for example by removing optional ingredients disliked by one or more attendee, while maintaining required ingredients for that specific menu item. Such changes may be requested to the vendor, for example.

In some embodiments of the present disclosure, a vendor can provide a first set of event features and related cost, comprising both optional and required event specifications. Required specifications of an event feature are characteristics that cannot be removed from that event feature. Optional specifications can be removed, instead.

A second set of event features can be provided by the attendees, comprising liked and/or disliked event features. A set of constraints can be provided by an event organizer.

The event features can then be decided based on, but not limited to, offered features, the liked and disliked specifications and feature, and the set of constraints.

For example, an event may be video content viewing by a group, and event features may be audio or video quality, such as 3D or Dolby or THX. Other specifications may be cost of the video ticket/rental/purchase, or genre of the movie. Some features or specifications may be liked or disliked, and may be offered from a vendor, or not, and have an associated cost. The event organizer may also specify constraints, for example, but not limited to, related to cost, preferred duration of video, and number of attendees.

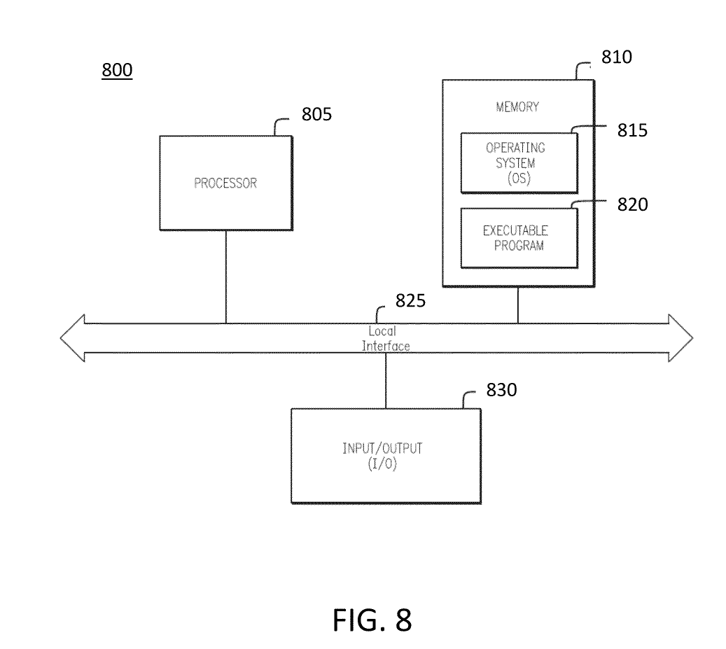

FIG. 8 is an exemplary embodiment of a target hardware (800) (e.g., a computer system) for implementing the embodiment of FIGS. 1-7 and FIGS. 9-23. This target hardware comprises a processor (805), a memory bank (810), a local interface bus (825) and one or more Input/Output devices (830). The processor may execute one or more instructions related to the implementation of FIGS. 1-7 and FIGS. 9-23, and as provided by the Operating System (815) based on some executable program (820) stored in the memory (810). These instructions are carried to the processor (805) via the local interface (825) and as dictated by some data interface protocol specific to the local interface and the processor (805). It should be noted that the local interface (825) is a symbolic representation of several elements such as controllers, buffers (caches), drivers, repeaters and receivers that are generally directed at providing address, control, and/or data connections between multiple elements of a processor based system. In some embodiments the processor (805) may be fitted with some local memory (cache) where it can store some of the instructions to be performed for some added execution speed. Execution of the instructions by the processor may require usage of some input/output device (830), such as inputting data from a file stored on a hard disk, inputting commands from a keyboard, inputting data and/or commands from a touchscreen, outputting data to a display, or outputting data to a USB flash drive. In some embodiments, the operating system (815) facilitates these tasks by being the central element to gathering the various data and instructions required for the execution of the program and provide these to the microprocessor. In some embodiments the operating system may not exist, and all the tasks are under direct control of the processor (805), although the basic architecture of the target hardware device (800) will remain the same as depicted in FIG. 8. In some embodiments a plurality of processors may be used in a parallel configuration for added execution speed. In such a case, the executable program may be specifically tailored to a parallel execution. Also, in some embodiments the processor (805) may execute part of the implementation of FIGS. 1-7 and FIGS. 9-23, and some other part may be implemented using dedicated hardware/firmware placed at an Input/Output location accessible by the target hardware (800) via local interface (825). The target hardware (800) may include a plurality of executable programs (820), wherein each may run independently or in combination with one another.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), a field programmable logic array (FPGA), a graphic processing unit (GPU) or a general purpose GPU).

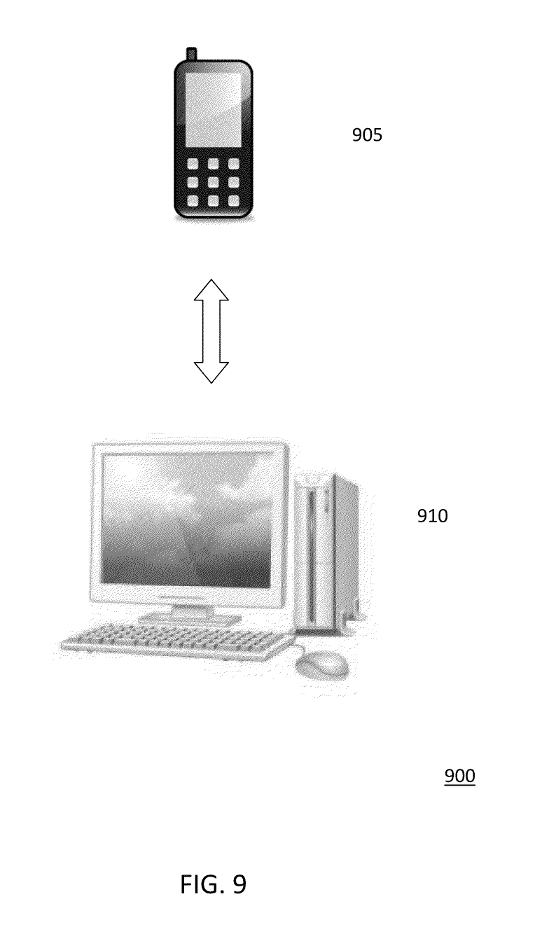

FIG. 9 illustrates an example embodiment of the present disclosure, where an application is running on a smartphone (905) and communicates with a computer (910), e.g. a desktop computer. For example, the smartphone may belong to a meal attendee and the computer to the provider. In another embodiment, the smartphone may belong to a video attendee and the computer to the provider. Other hardware devices may be used, for example, but not limited to, a tablet instead of a smartphone.

In one embodiment of the invention, an algorithm can be used to estimate the correlation between ratings of an item and the presence and quantity of ingredients that are present in the item. An algorithm can also be used to estimate the correlation between ratings and the simultaneous presence of multiple ingredients. This may be done using many mathematical methods including, but not limited to, a regression model whose coefficients can be calculated to signify the correlation.

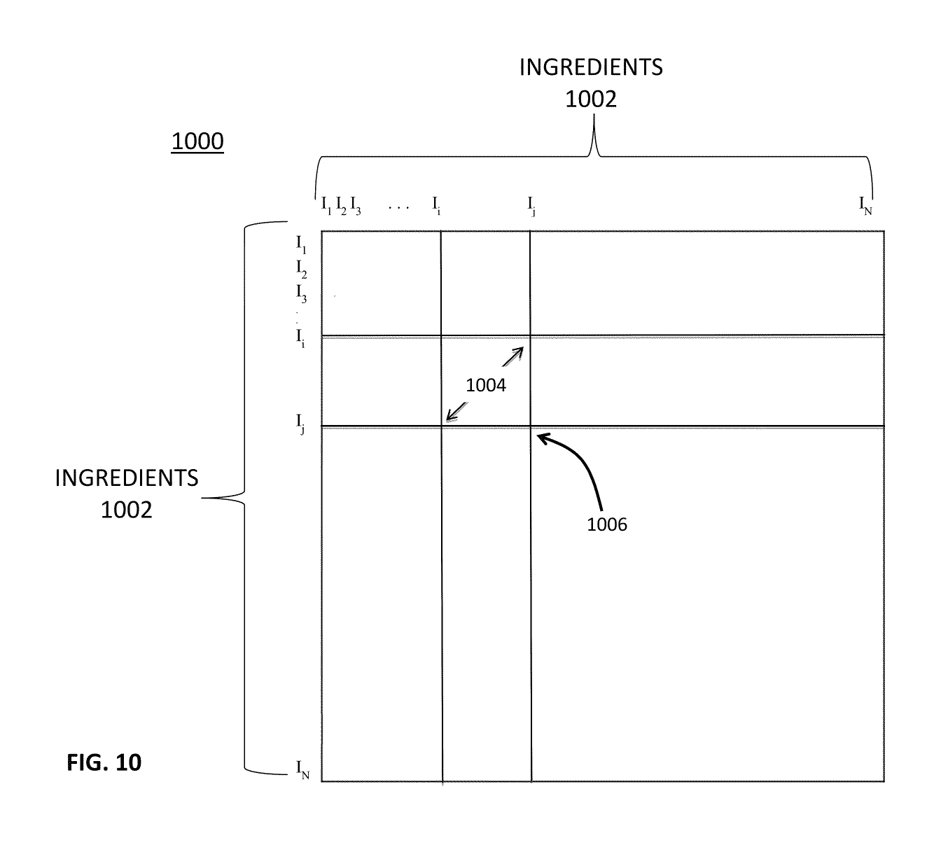

FIG. 10 displays a correlation matrix of ingredient (1002) to rating and ingredient pairs to rating. This cooperative correlation can be illustrated between two particular ingredients in relation to rating within an individual menu item (1004). Point (1006) indicates no correlation exists in pairs of the same ingredient.

In one embodiment of the invention, the estimated ingredient pairing coefficients can be used to pair item instances between course types in the same meal. For example, if a high positive correlation is observed between rating and items with salt and pepper, the meals may be designed to include item instances with salt and pepper or two or more item instance with salt and pepper in separate instances.

FIG. 11 illustrates the use of the remedy set as an alternative method to meal assignment. For example, a first step may be to obtain the list of users who cannot be matched with item instances at the current vendor (1102). A subsequent step may be to obtain a list of full ingredient sets present in the vendor (1104). A further step may be to obtain a global list of items with individual item ingredient sets (1106).

A next step may be to calculate the expected price of global menu items based on item cost in the parent vendor menu and scale against current prices of the providing vendor (1108). A next step may be to select the minimal set of items from this global list to satisfy all remaining unsatisfied users based on the original meal constraints, vendor ingredient set and user ingredient preferences (1110). A next step may be to provide the vendor with the newly assigned menu items, their related details, and suggested prices (1112).

The person skilled in the art will understand that several steps in the methods described in the present disclosure may require a hardware implementation. For example, but not limited to, a tablet, smartphone, server or other computer may be needed to implement one or more steps of the methods described herein.

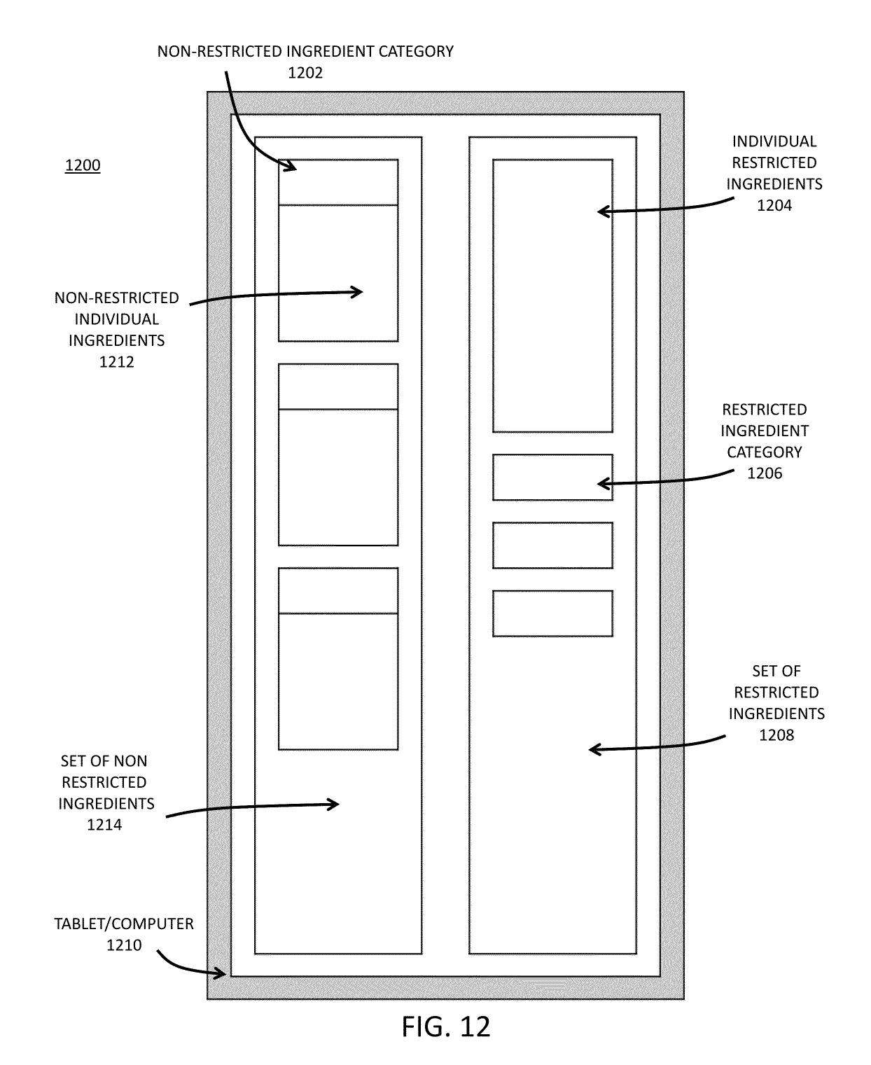

FIG. 12 illustrates an exemplary method for attendees to set ingredient preferences according to an embodiment. It can be used in the context of a meal, for example. In FIG. 12, a category in the non-restricted section (1202) means that not all its constituent ingredients are set to restrict. A category in the restricted section means all its constituent ingredients are also set to restrict.

An application implementing an embodiment of the methods of the present disclosure may display on a screen (1210) of a tablet or computer, a set of non-restricted ingredients (1214), a set of restricted ingredients (1208), a restricted ingredient category (1206), individual restricted ingredients (1204), and non-restricted individual ingredients (1212).

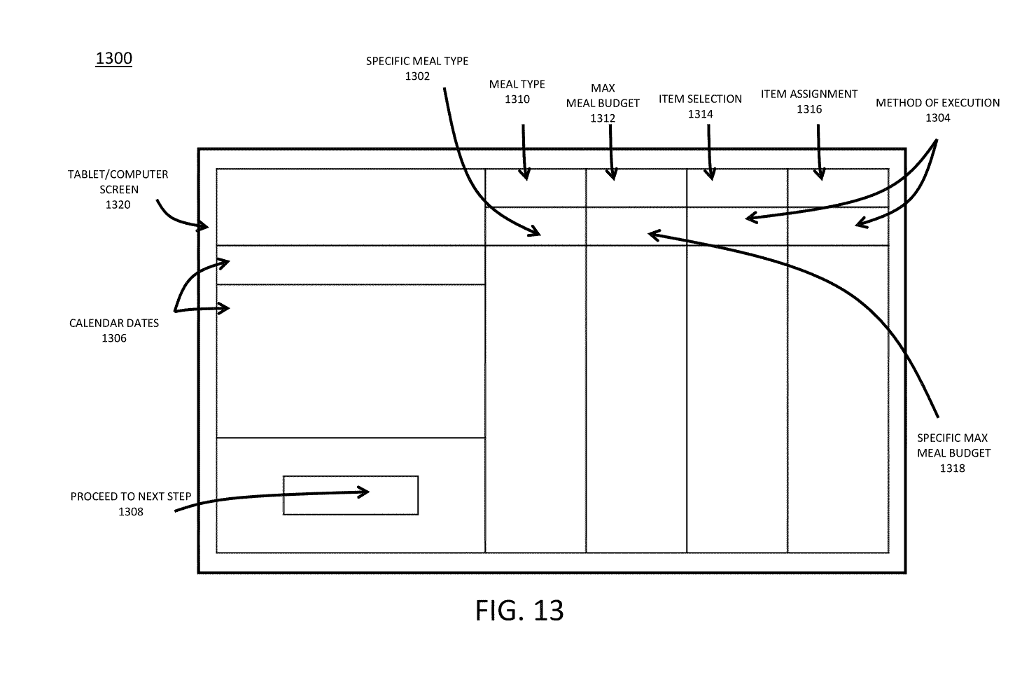

FIG. 13 illustrates an exemplary method for an organizer to initiate a group meal according to an embodiment. An application implementing an embodiment of the methods of the present disclosure may display on a screen (1320) of a tablet or computer. Calendar dates (1306) is used to set time/day of meals. Meal Type (1310) is a singular instance of Breakfast, Lunch, Dinner, etc. Max Meal Budget (1312) is the maximum cost that a specific meal can be for all attendees of that group. Specific Max Meal Budget (1318) is a specified max budget for Specific Meal Type (1302). Method of Execution (1304) can be automated or manual. Item Selection (1314) stands for the selection of the set of items for a group meal which can be executed in a manual or automated fashion. Item assignment (1316) stands for the assignment of items from the set of items to individual attendees of a group meal which can be done in an automated or manual fashion. This is a simplified example, where all attendees are presumed to be the same for all the meal types.

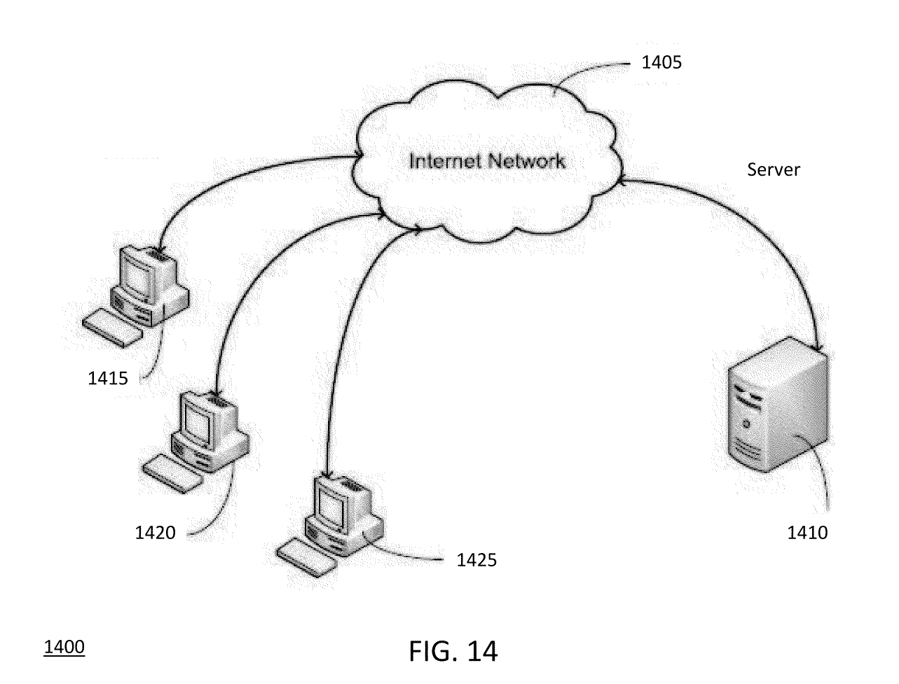

FIG. 14 illustrates an exemplary connection between a server and computers, wherein the server (1410) may run an application implementing the methods of the present disclosure. The server (1410) may connect through a network (1405) to other computers such as an attendee computer (1415), a vendor computer (1420) and an event-organizer computer (1425). A network may comprise, for example, a LAN, a WAN, or other kinds of networks as understood by the person skilled in the art. Such networks may be wholly or partly private networks.

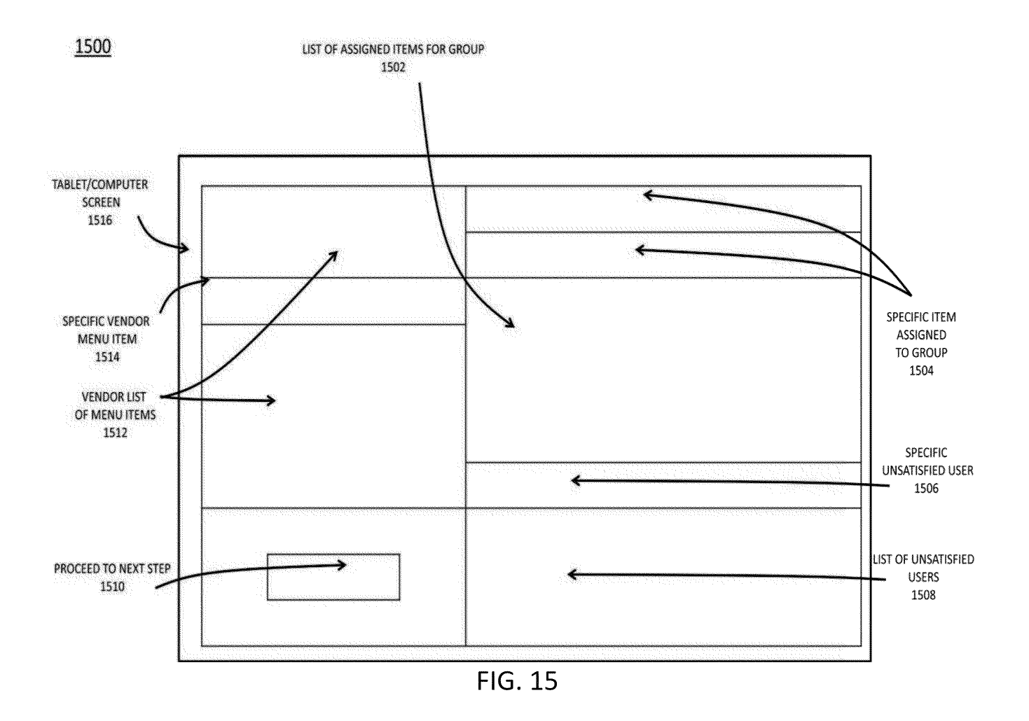

FIG. 15 illustrates an exemplary method for a second step for an organizer to initiate a group meal according to an embodiment. An application implementing an embodiment of the methods of the present disclosure may display on a screen (1516) of a tablet or computer. The list of vendor items (1512, 1514) denotes the complete list of items from the vendor, excluding the assigned items to the group (1502, 1504). The list of assigned items for the group (1502, 1504) represents the total set of items for the group. This exemplary method is simplified to only show one set of assigned items, in another embodiment more than one set of equally good assigned items may be displayed. Unsatisfied users (1506, 1508) are users that are not satisfied given the use of the current set of assigned menu items (1502, 1504). In another embodiment, it might be possible to run a remedy solution for these unsatisfied users. Assigned menu items (1502, 1504) may be removed and replaced with items from the vendor list (1512, 1514), in which case the list of unsatisfied users (1506, 1508) would automatically update.

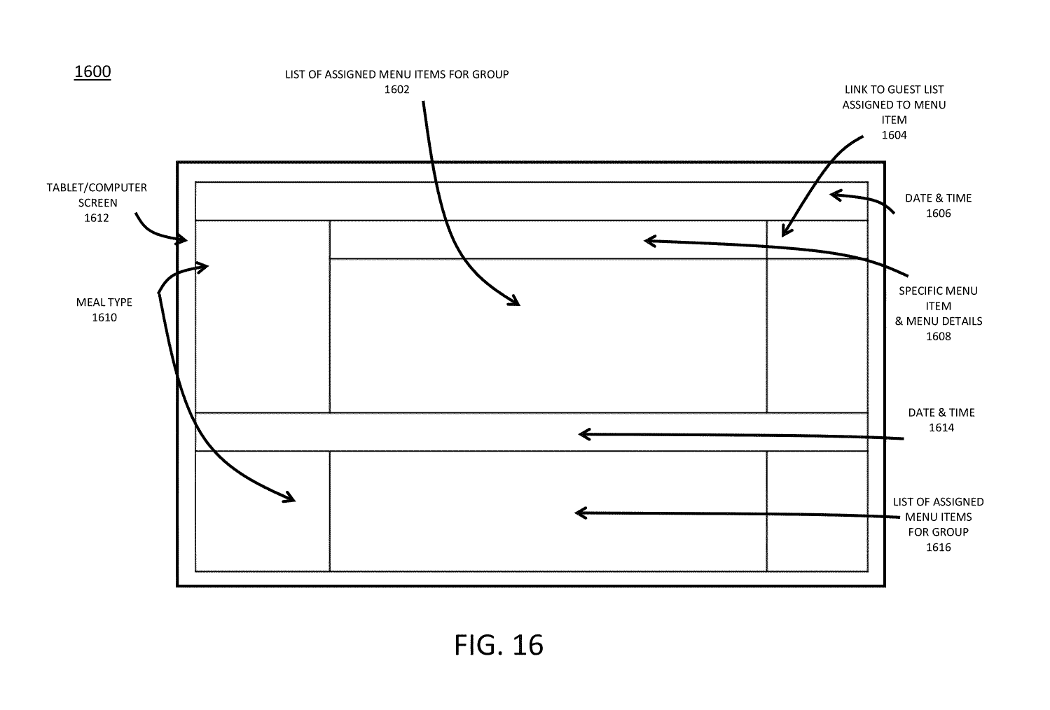

FIG. 16 illustrates an exemplary method for a final step for an organizer to initiate a group meal according to an embodiment. An application implementing an embodiment of the methods of the present disclosure may display on a screen (1612) of a tablet or computer. It displays the list of assigned menu items for the group (1602, 1608, 1616), and who within the group is assigned which items (1604). It also displays different dates and times (1606, 1614) in the event that there are more than one set of meals being served, and the various menu items and assigned attendees for each of the menu items over the various meal types (which may be Breakfast, Lunch, Dinner, etc). For example, meal types may be displayed in areas (1610).

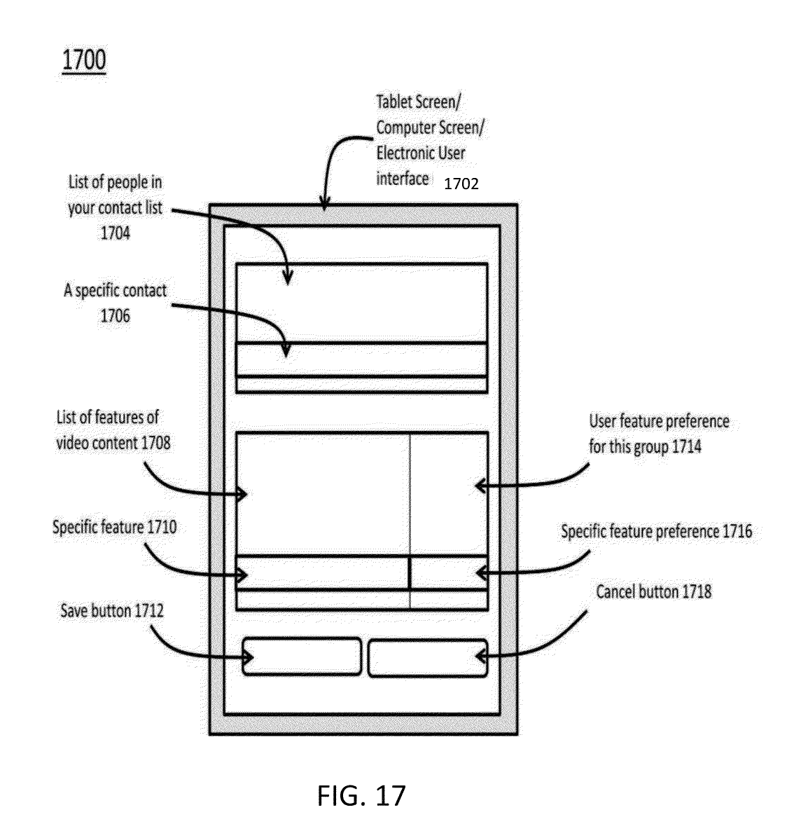

FIG. 17 illustrates an exemplary method for an attendee of a group video to explicitly specify their preferences according to the present disclosure. In another embodiment, the specifications may be implicitly stored. An application implementing an embodiment of the methods of the present disclosure may display on a screen (1702) of a tablet or computer.

A list of contacts of the attendee may be displayed (1704). A specific contact may be visible (1706). A list of features of video content may be available (1708), and a specific feature may be selected (1710). Preferences for group viewing related to the attendee may be visible (1714), with a specific feature highlighted (1716). Save (1712) and cancel (1718) buttons may be present.

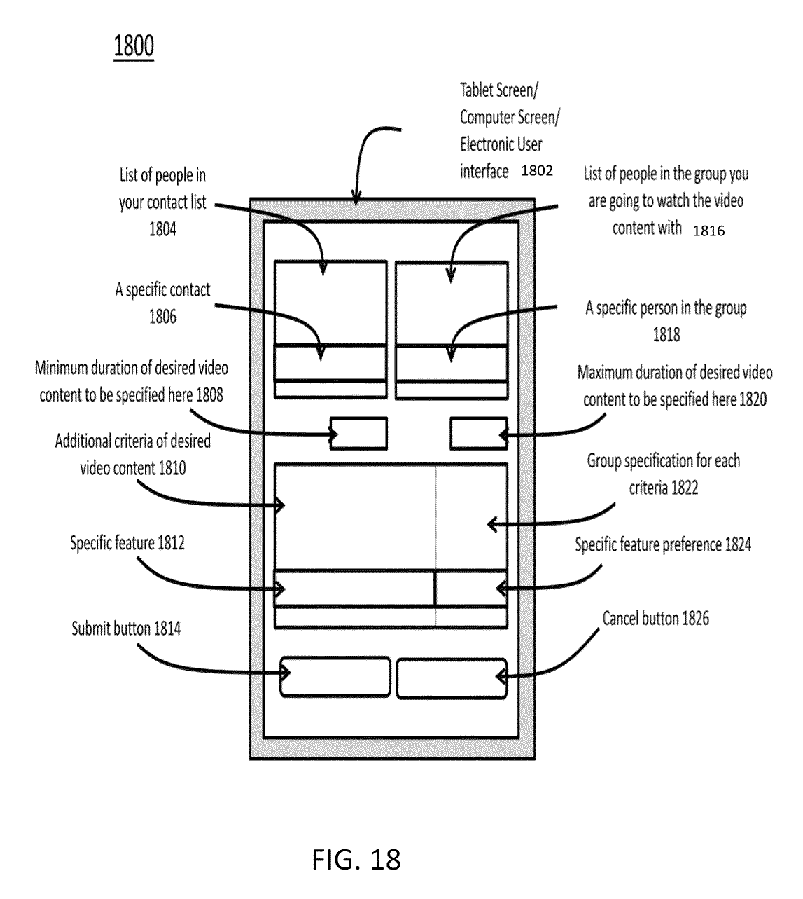

FIG. 18 illustrates an exemplary method for a first step for an organizer to initiate a video for group viewing according to the present disclosure. An application implementing an embodiment of the methods of the present disclosure may display on a screen (1802) of a tablet or computer.

A list of contacts of the organizer may be displayed (1804). A specific contact may be visible (1806). A group of people belonging to the group which is going to view a video can be displayed (1816). A specific person who is a member of the group may be visible (1818). A maximum duration of video content specified as a preference may be visible (1820); the minimum duration may also be specified (1808). Preferences for the group may be visible for each criteria (1822), with a specific feature highlighted (1824). Additional criteria may also be visible (1810). A specific feature may be highlighted (1812). Save (1814) and cancel (1826) buttons may be present.

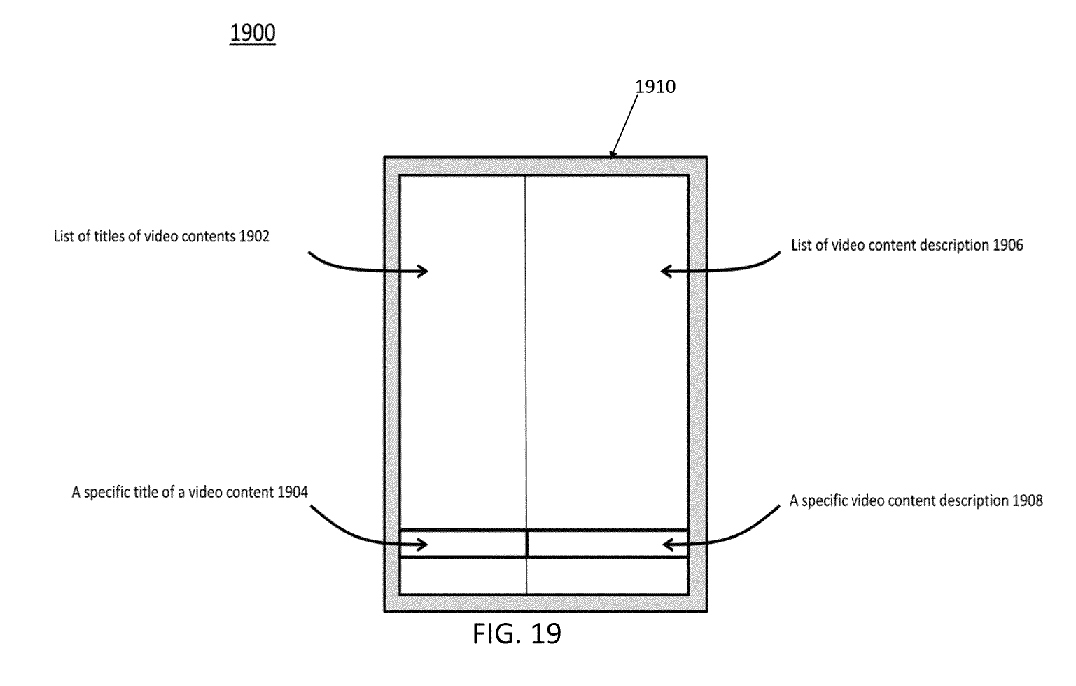

FIG. 19 illustrates an exemplary method for a final step/display of recommended video items of a video for group viewing according to the present disclosure. An application implementing an embodiment of the methods of the present disclosure may display on a screen of a tablet or computer. A list of titles of video content may be available (1902), with accompanying description (1906). A specific title may be selected (1904), with its corresponding description visible (1908). An application implementing an embodiment of the methods of the present disclosure may display on a screen (1910) of a, but not limited to, tablet or computer.

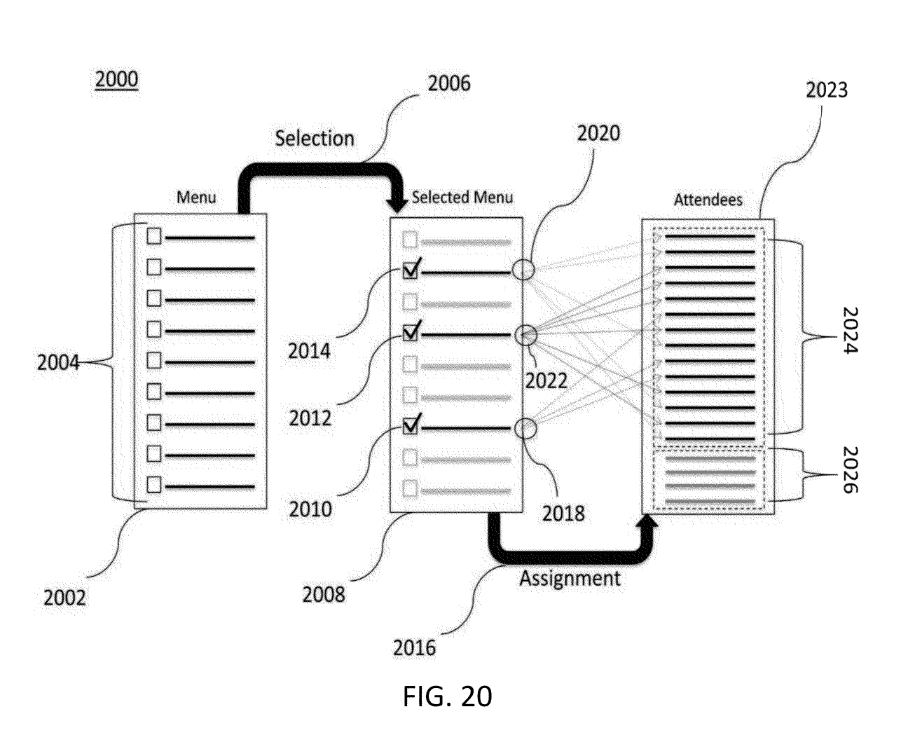

FIG. 20 illustrates an exemplary distinction between selecting menu items, and assigning menu items to attendees. A menu (2002) may comprise menu items (2004). Some of the menu items (2004) may be selected (2006) by an organizer based on their constraints and/or attendee preferences, thus obtaining a subset of selected menu items (2008), for example comprising items (2010, 2012, 2014). Some instances of the menu items (2008), for example (2018, 2020, 2022), may then be assigned (2016), obtaining a list (2023) comprising attendees assigned menu items (2024) and attendees not assigned menu (2026) items.

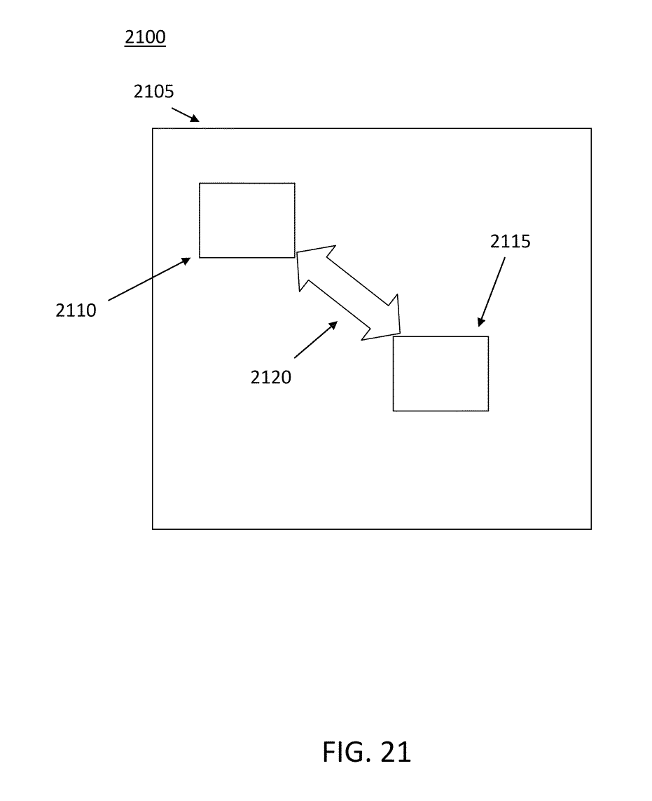

FIG. 21 illustrates an exemplary apparatus for the methods of the present disclosure. The apparatus (2105) may comprise a memory (2110) and a processor (2115) communicatively coupled to the memory. The communication may be for example through a bus (2120). The processor may be configured to estimate attendee preferences, the attendee preferences comprising attendee-liked ingredients and/or attendee-disliked ingredients; identify a set of ingredients within a menu item that are optional; identify a set of ingredients within a menu item that are required; identify common ingredients between the set of required or optional ingredients within the menu item, and attendee-liked ingredients and/or attendee-disliked ingredients; and execute the methods described in the present disclosure.

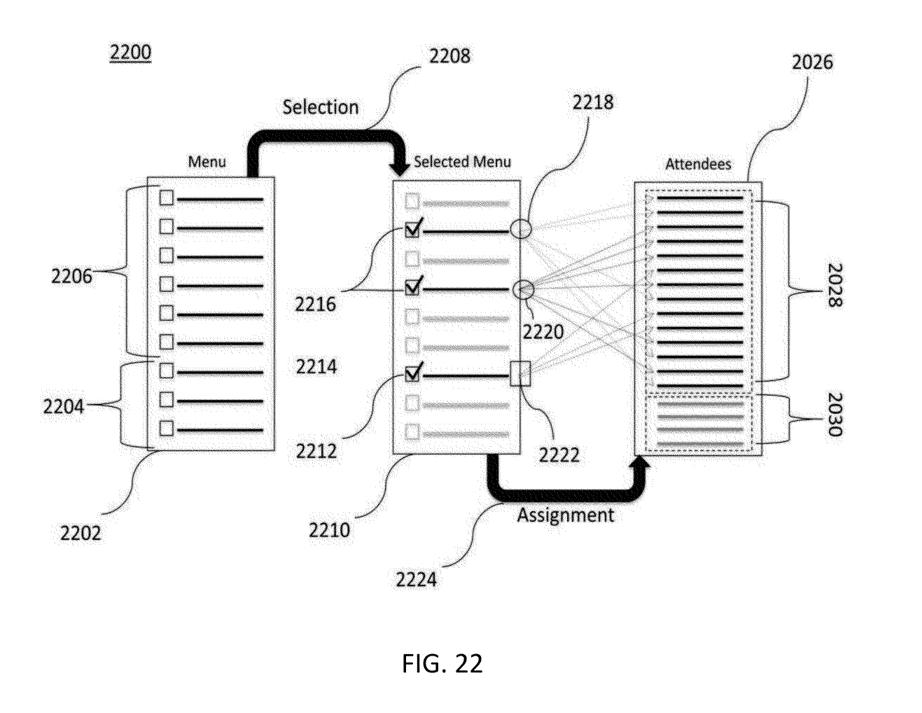

FIG. 22 illustrates an embodiment where a buffet selection is included. FIG. 22 shows a combined use of a buffet and single items in a menu. The embodiment of FIG. 22 works similarly to that of FIG. 20, however the menu is now shown as element (2206), while element (2204) is a buffet set section. The selection (2208) and assignment (2224) may operate similarly to as described in FIG. 20, as understood by the person skilled in the art.

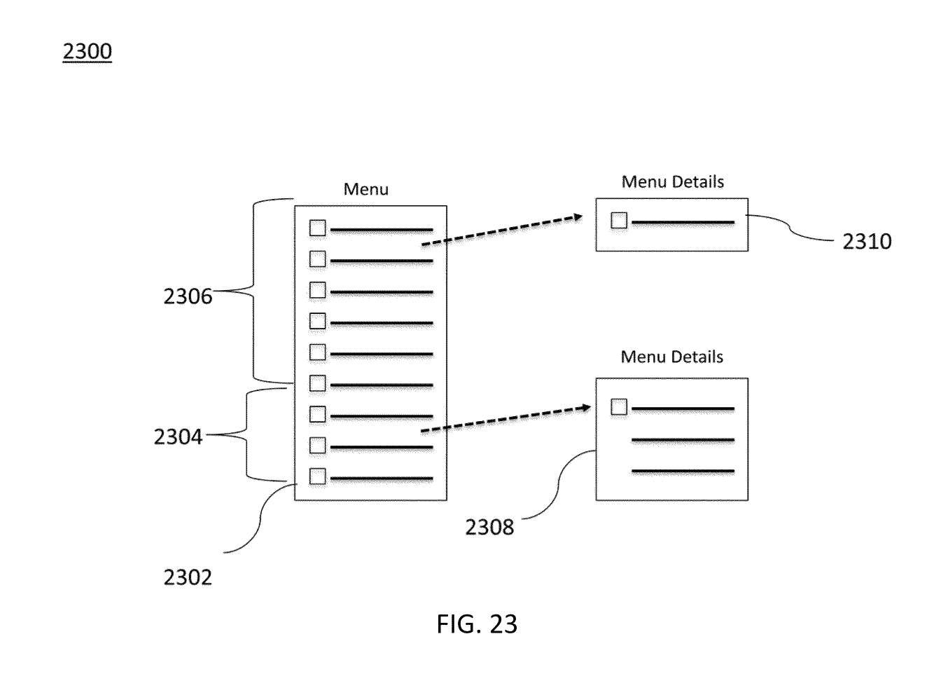

FIG. 23 illustrates how a menu can be composed of buffet and single item sets and how they are different. A menu (2302) may comprise a single item part (2306) and a buffet part (2304). Menu details may be provided for the single items part (2310) and for the buffet part (2308).

In one embodiment, a system to handle all the data and processing described earlier can be realized through a website built using Microsoft .NET® platform and combining markup languages, database management tools and programming languages such as HTML/CSS®, Microsoft SQL®, JavaScript®, Python® and C# R.

In another embodiment other platforms and languages may be used to build such a website.

In some embodiments, the methods and systems of the present disclosure may provide, by a computer, multiple menus from the vendor; and select, by a computer, one of the multiple menus based on the correlation, for each of the multiple menus, between the attendee-liked ingredients and each menu and/or between the attendee-disliked ingredients and each menu.

In some embodiments, the methods and systems of the present disclosure may provide, by a computer, menus from multiple vendors; and select, by a computer, at least one of the vendors based on the correlation, for each of the menus from multiple vendors, between the attendee-liked ingredients and each menu and/or between the attendee-disliked ingredients and each menu.

In some embodiments, the methods and systems of the present disclosure may provide a list of previously attended meals for at least one attendee, and assign menu items to attendees further based on the list of previously attended meals.

In some embodiments, a list of previously attended meals for attendees can be provided, describing what meals an attendee has previously attended.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an” and “the” include plural referents unless the content clearly dictates otherwise. The term “plurality” includes two or more referents unless the content clearly dictates otherwise. Unless defined otherwise, all technical and scientific terms used herein have the same meaning as commonly understood terms by one of ordinary skill in the art to which the disclosure pertains.

What is claimed is:

1. A computer-implemented method comprising:
providing, by a computer, vendor-related menu items and cost of said vendor-related menu items, wherein the vendor-related menu items comprise optional and/or required ingredients;
providing, by a computer, a set of attendee-related ingredients, wherein the set of attendee-related ingredients comprises attendee-liked and/or attendee-disliked ingredients;
providing, by a computer, a set of organizer constraints;
selecting, by a computer, a subset of the vendor-related menu items for the attendees, based on the set of organizer constraints and the set of attendee-related ingredients, wherein the selecting comprises establishing a correlation between the attendee-liked ingredients and selected menu items and/or between the attendee-disliked ingredients and selected menu items, thereby obtaining a selected subset; and
assigning, by a computer, the selected subset of vendor-related menu items to the attendees, based on the set of organizer constraints and the set of attendee-related ingredients, wherein the assigning comprises establishing a correlation between the attendee-liked ingredients and assigned menu items and/or between the attendee-disliked ingredients and assigned menu items.

2. The method of claim 1, wherein the providing, by a computer, a set of attendee-related ingredients comprises checking, by a computer, whether the set of ingredients is already stored in a non-volatile database of sets of ingredients.

3. The method of claim 1, wherein the assigning, by a computer, the selected subset of vendor-related menu items to the attendees comprises requesting, by a computer, a new set of constraints from the organizer.

4. The method of claim 1, further comprising requesting, by a computer, the vendor to provide the assigned menu items at a specific time and date.

5. The method of claim 1, further comprising requesting, by a computer, the attendees to provide an attendee feedback rating regarding at least one of the menu item, the organizer and the vendor, and storing said attendee feedback rating in a non-volatile database.

6. The method of claim 1, further comprising providing automated recommendation of possible menu items to at least one of the organizer and attendees, based on vendor menu data and on preference data of the attendees stored in a non-volatile database.

7. The method of claim 5, further comprising requesting, by a computer, the organizer to provide an organizer feedback rating regarding the group meal, and storing said organizer feedback rating in a non-volatile database.

8. The method of claim 7, wherein the assigning, by a computer, the selected subset of vendor-related menu items to the attendees is based on the stored organizer feedback rating and the stored attendee feedback rating.

9. The method of claim 1, wherein the assigning, by a computer, the selected subset to the attendees comprises removing, by a computer, one or more optional ingredients from a specific menu item.

10. The method of claim 1, wherein the selecting, by a computer, a subset of the vendor-related menu items to the attendees comprises removing, by a computer, one or more optional ingredients from a specific menu item.

11. The method of claim 1, wherein the set of constraints comprises optional constraints.

12. The method of claim 1, wherein the set of constraints is selected from the group comprising: maximum number of menu items to be served to each attendee, minimum number of menu items to be served to each attendee, maximum number of menu items to be served to all attendees, maximum cost for the meal, maximum cost for each attendee, list of attendees attending meal, meal type, preferred number of menu items, time and date of serving, and preferred cost of menu items.

13. The method of claim 1, wherein the establishing a correlation between the attendee-liked ingredients and assigned menu items comprises maximizing a correlation between the attendee-liked ingredients and the assigned menu items.

14. The method of claim 1, wherein the establishing a correlation between the attendee-disliked ingredients and assigned menu items comprises minimizing a correlation between the attendee-disliked ingredients and the assigned menu items.

15. The method of claim 1, wherein the assigning, by a computer, the selected subset of vendor-related menu items to the attendees comprises a vendor selecting, by a computer, at least one menu item available from another vendor.

16. A system to organize a group meal, the system comprising:
an attendee device, configured to run a first application implementing the method of claim 1;
a vendor device, configured to run a second application implementing said method; and
an organizer device, configured to run a third application implementing said method.

17. The system of claim 16, wherein the attendee device, the vendor device, or the organizer device are a smartphone, a tablet, a laptop, a portable electronic device or a desktop computer.

18. A method to organize an event, the method comprising:
providing, by a computer, vendor-related event features, wherein the vendor-related event features comprise optional and/or required event specifications;
providing, by a computer, attendee-related event features, wherein the attendee-related event features comprise attendee-liked and/or attendee-disliked event features and specifications;
providing, by a computer, a set of organizer constraints; and
selecting, by a computer, at least one of the vendor-related event features, based on the set of organizer constraints and the attendee-related event features, wherein the selecting comprises establishing a correlation between the attendee-liked event features and selected event features and/or between the attendee-disliked event features and the selected event features.

19. The method of claim 18, wherein the establishing a correlation between the attendee-liked event features and assigned event features comprises maximizing a correlation between the attendee-liked event features and the selected event features.

20. The method of claim 18, wherein the establishing a correlation between the attendee-disliked event features and assigned event features comprises minimizing a correlation between the attendee-disliked event features and the selected event features.

21. The method of claim 18, wherein the event is video-viewing and the event specifications comprise at least one of genre, talent, language, film ratings, and audio or video quality requirements.

22. The method of claim 1, further comprising providing a server configured to connect to attendee computers, vendor computers and organizer computers, wherein the server is further configured to implement the method of claim 1.

23. The method of claim 18, further comprising providing a server configured to connect to attendee computers, vendor computers and organizer computers, wherein the server is further configured to implement the method of claim 18.

24. The method of claim 22, further comprising showing on an attendee computer screen a list of ingredients to select.

25. The method of claim 1, further comprising:
providing, by a computer, multiple menus from the vendor; and
selecting, by a computer, at least one of the multiple menus based on the correlation, for each of the multiple menus, between the attendee-liked ingredients and each menu and/or between the attendee-disliked ingredients and each menu.

26. The method of claim 1, further comprising:
providing, by a computer, menus from multiple vendors; and
selecting, by a computer, at least one of the vendors based on the correlation, for each of the menus from the multiple vendors, between the attendee-liked ingredients and each menu and/or between the attendee-disliked ingredients and each menu.

27. The method of claim 1, further comprising providing, by a computer, a list of previously attended meals for at least one attendee, and wherein the assigning is further based on the list of previously attended meals.

28. An apparatus comprising:
a memory; and
a processor communicatively coupled to the memory, the processor configured to
estimate attendee preferences, the attendee preferences comprising attendee-liked ingredients and/or attendee-disliked ingredients;
identify a set of ingredients within a menu item that are optional;
identify a set of ingredients within a menu item that are required;
identify common ingredients between the set of required and optional ingredients within the menu item, and attendee-liked ingredients and/or attendee-disliked ingredients; and
execute the method of claim 1.

29. A computer-implemented method comprising:
providing, by a computer, vendor-related menu items and cost of said vendor-related menu items, wherein the vendor-related menu items comprise optional and/or required ingredients;
providing, by a computer, a set of attendee-related ingredients, wherein the set of attendee-related ingredients comprises attendee-liked and/or attendee-disliked ingredients;
providing, by a computer, a set of organizer-related constraints; and
selecting, by a computer, a subset of the vendor-related menu items for the attendees, based on the set of organizer constraints and the set of attendee-related ingredients, wherein the selecting comprises establishing a correlation between the attendee-liked ingredients and selected menu items and/or between the attendee-disliked ingredients and selected menu items, thereby obtaining a selected subset.

30. The method of claim 29, further comprising
providing, by a computer, at least one buffet set and cost of said at least one buffet set, wherein the at least one buffet set comprises a plurality of items; and
selecting, by a computer, at least one buffet set for the attendees, based on the set of organizer-related constraints and the set of attendee-related ingredients, wherein the selecting comprises establishing a correlation between the attendee-liked ingredients and selected buffet set and/or between the attendee-disliked ingredients and selected buffet set, thereby obtaining a selected buffet set.

31. The method of claim 30, further comprising estimating a quantity of each item of the plurality of items, based on a total number of attendees, the attendee-liked ingredients and the attendee-disliked ingredients.

32. The method of claim 30, wherein the at least one buffet is vendor-related, attendee-related, or organizer-related.
